(19) United States
(12) Patent Application Publication
(10) Pub. No.: US 2013/0334937 A1
(43) Pub. Date: Dec. 19, 2013

(54) ROTARY ELECTRIC MACHINE DRIVING SYSTEM

(71) Applicants: Eiji Yamada, Owariasahi-shi (JP); Ryoji Mizutani, Nagoya-shi (JP); Kenji Hiramoto, Owariasahi-shi (JP); Hideo Nakai, Nisshin-shi (JP); Norimoto Minoshima, Kariya-shi (JP)

(72) Inventors: Eiji Yamada, Owariasahi-shi (JP); Ryoji Mizutani, Nagoya-shi (JP); Kenji Hiramoto, Owariasahi-shi (JP); Hideo Nakai, Nisshin-shi (JP); Norimoto Minoshima, Kariya-shi (JP)

(73) Assignee: TOYOTA JIDOSHA KABUSHIKI KAISHA, Toyota-shi, Aichi-ken (JP)

(21) Appl. No.: 13/997,892

(22) PCT Filed: Feb. 14, 2012
(86) PCT No.: PCT/IB2012/000266

§ 371 Date: Jun. 25, 2013

(30) Foreign Application Priority Data
Feb. 15, 2011 (JP) 2011-029816

(51) Int. Cl. H02K 11/00

(52) U.S. Cl. CPC H02K 11/0073
USPC 310/68 D

(57) ABSTRACT

A stator has multi-phase stator coils that are wound around a stator core by concentrated winding. A rotor has rotor coils that are wound at multiple portions of a rotor core in the circumferential direction and diodes that serve as rectifier unit that is connected to the rotor coils and that varies the magnetic characteristics of the respective rotor coils alternately in the circumferential direction. A rotary electric machine driving system includes a decreasing pulse superimposing unit that superimposes decreasing pulse current for a pulse-shaped decrease on a q-axis current command for passing currents through the stator coils.

### BACKGROUND OF THE INVENTION

1. Field of the Invention

The invention relates to a rotary electric machine driving system that includes a rotary electric machine having a stator and a rotor that are arranged to face each other, a driving unit that drives the rotary electric machine and a control unit that controls the driving unit.

2. Description of Related Art

As is described in Japanese Patent Application Publication No. 2009-112091 (JP-A-2009-112091), there is known a rotary electric machine in which rotor coils are provided for a rotor and induced currents are generated in the rotor coils by a revolving magnetic field to cause the rotor to generate torque. The revolving magnetic field is generated by a stator, and includes space harmonics. In addition, with this rotary electric machine, induced currents are efficiently generated in the rotor coils to make it possible to obtain the effect of efficiently increasing torque that acts on the rotor. FIG. 21 to FIG. 23 show the schematic configuration of the rotary electric machine described in JP-A-2009-112091. FIG. 21 is a view that shows the schematic configuration of a stator and rotor when viewed in the direction parallel to the rotation axis of the rotor. FIG. 22 shows the schematic configuration of the stator. FIG. 23 shows the schematic configuration of the rotor.

However, in the case of the rotary electric machine 10 shown in FIG. 21 to FIG. 23, there is still room for improvement in terms of effectively increasing torque during low-speed rotation where the rotation speed of the rotary electric machine 10 is low. FIG. 24 is a graph that shows an example of the correlation between a rotor rotation speed and a motor torque in a range in which the rotation speed is low when the same configuration as that of the rotary electric machine shown in FIG. 21 to FIG. 23 is used as an electric motor (motor). As shown in FIG. 24, the motor torque of the rotary electric machine 10 significantly decreases in the range in which the rotation speed is low. This is because, when description will be made with reference to FIG. 21 to FIG. 23, in the rotary electric machine 10, rotor induced currents that flow through rotor coils 18n and 18s are generated by magnetic field fluctuations due to the harmonic components of the revolving magnetic field generated by a stator 12, while magnetic fluxes that link with the rotor coils 18n and 18s do not change significantly in the range in which the rotation speed is low but the fluctuation velocity of linked magnetic fluxes decreases, so induced electromotive voltages decrease to reduce the rotor induced currents. Therefore, the motor torque reduces during low-speed rotation. Note that, in the above description, the motor torque decreases when the rotary electric machine 10 is used as an electric motor in the range in which the rotation speed is low; however, when the rotary electric machine 10 is used as a generator as well, regenerative torque may significantly decrease in the low-rotation speed range because of the same reason.

### SUMMARY OF THE INVENTION

The inventors have an idea that there is a possibility that pulse current is superimposed on alternating currents to be passed through stator coils to increase induced currents generated in rotor coils to thereby make it possible to increase the torque of a rotary electric machine even in a low rotation speed range. However, the inventors found that, unless a method of superimposing pulse current is devised, the peak values of currents that flow through the stator coils become excessive and this may lead to inconvenience, such as an increase in size and cost of a control system that includes an inverter that is a rotary electric machine driving unit.

In contrast to this, Japanese Patent Application Publication No. 2007-185082 (JP-A-2007-185082), Japanese Patent Application Publication No. 2010-98908 (JP-A-2010-98908) and Japanese Patent Application Publication No. 2010-110079 (JP-A-2010-110079) describe a field winding synchronous machine that utilizes superimposition of pulse current; however, these publications do not describe measures for increasing torque while preventing excessive currents from flowing through the stator coils.

The invention implements a rotary electric machine that is able to increase torque even in a low rotation speed range while preventing excessive currents from flowing through stator coils in a rotary electric machine driving system.

A first aspect of the invention relates to a rotary electric machine driving system that includes: a rotary electric machine having a stator and a rotor that are arranged so as to face each other; a driving unit that drives the rotary electric machine; and a control unit that controls the driving unit. The stator has a stator core having a plurality of stator slots at intervals in a circumferential direction around a rotation axis of the rotor and multi-phase stator coils that are wound around the stator core via the stator slots by concentrated winding, the rotor has a rotor core having a plurality of rotor slots at intervals in the circumferential direction around the rotation axis of the rotor, rotor coils that are wound at multiple portions of the rotor core in the circumferential direction so as to be at least partially arranged in the rotor slots and a rectifier unit that is connected to the rotor coils and that varies magnetic characteristics of the respective rotor coils alternately in the circumferential direction among the plurality of rotor coils, and the rotor varies magnetic characteristics of magnetic pole portions at multiple portions in the circumferential direction alternately in the circumferential direction, the magnetic characteristics being generated by currents flowing through the respective rotor coils, and the control unit has a decreasing pulse superimposing unit that superimposes decreasing pulse current for a pulse-shaped decrease on a q-axis current command for passing currents through the stator coils so as to generate field magnetic fluxes in directions advanced by 90 degrees in electric angle with respect to magnetic pole directions that are winding central axis directions of the respective rotor coils. Note that the decreasing pulse current means pulse current that steeply decreases and then steeply increases in a pulse-shaped manner. In addition, the pulse-shaped waveform of the decreasing pulse current may be any of a rectangular wave, a triangular wave and a waveform formed from a plurality of curves and/or lines into a projecting shape. Note that the “rotor core” means an integral member other than the rotor coils in the rotor, and may be, for example, formed of magnets and a rotor core body made of a magnetic material. In addition, the “rotor slots” are not limited to portions that have a groove shape and that open to the peripheral surface of the rotor core, and, for example, include slits that do not open to the peripheral surface of the rotor core and that are formed to extend through in the axial direction inside the rotor core.

With the rotary electric machine driving system, it is possible to implement a rotary electric machine that is able to increase torque even in a low rotation speed range while preventing excessive currents from flowing through stator coils. For example, when the multi-phase stator coils are three-phase stator coils, even when the absolute value of current that flows through the stator coils of one phase (for example, W phase) is higher than the absolute value of each of currents that flow through the stator coils of the other phases (for example, U phase and V phase) before superimposing pulse current on current flowing through the stator coils of the one phase (for example, W phase), decreasing pulse current is superimposed to make it possible to increase induced currents that occur in the rotor coils while decreasing the absolute values of currents flowing through the stator coils of all the phases in a pulse-shaped manner. Therefore, it is possible to increase the torque of the rotary electric machine even in a low rotation speed range while suppressing the peaks of stator currents that are currents to be passed through all the stator coils.

Each of the rotor coils may be connected to any one of rectifier elements that serve as the rectifier unit and of which forward directions are opposite between any adjacent two of the rotor coils in the circumferential direction of the rotor, and the rectifier elements may rectify currents that are generated by induced electromotive forces to flow through the rotor coils to thereby vary phases of currents flowing through any adjacent two of the rotor coils in the circumferential direction alternately between an A phase and a B phase.

The rectifier elements may be a first rectifier element and a second rectifier element that are respectively connected to the corresponding rotor coils, and the first rectifier element and the second rectifier element may independently rectify currents generated due to the generated induced electromotive forces so that the rectified currents flow through the corresponding rotor coils, and may vary the magnetic characteristics of the magnetic pole portions at multiple portions in the circumferential direction alternately in the circumferential direction, the magnetic characteristics being generated by currents flowing through the respective rotor coils.

The rotor core may include salient poles that are the plurality of magnetic pole portions that are arranged at intervals in the circumferential direction of the rotor and that protrude toward the stator, and the salient poles may be magnetized as currents rectified by the rectifier unit flow through the rotor coils to thereby function as magnets having fixed magnetic poles.

The rotor core may include salient poles that are the plurality of magnetic pole portions that are arranged at intervals in the circumferential direction of the rotor and that protrude toward the stator, and the salient poles may be magnetized as currents rectified by the rectifier elements flow through the rotor coils to thereby function as magnets having fixed magnetic poles, and the rotor may further have auxiliary rotor coils that are wound at proximal portions of the respective salient poles, any two of the auxiliary rotor coils wound around any adjacent two of the salient poles in the circumferential direction of the rotor may be connected in series with each other to constitute an auxiliary coil set, and one ends of any adjacent two of the rotor coils, wound around any adjacent two of the salient poles in the circumferential direction of the rotor, may be connected to each other at a connection point via the respectively corresponding rectifier elements such that the respectively corresponding rectifier elements face each other in opposite directions, the other ends of the any adjacent two of the rotor coils, wound around any adjacent two of the salient poles in the circumferential direction of the rotor, each may be connected to one end of the auxiliary coil set, and the connection point may be connected to the other end of the auxiliary coil set.

A width of each salient pole in the circumferential direction of the rotor may be smaller than a width corresponding to 180° in electric angle, and each of the rotor coils may be wound around a corresponding one of the salient poles by short pitch winding.

A width of each rotor coil in the circumferential direction of the rotor may be equal to a width corresponding to 90° in electric angle.

With the rotary electric machine driving system according to the aspect of the invention, it is possible to implement the rotary electric machine that is able to increase torque even in a low rotation speed range while preventing excessive currents from flowing through the stator coils.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view that shows the schematic configuration of a rotary electric machine driving system according to an embodiment of the invention;

FIG. 2 is a schematic view that partially shows a portion at which a stator faces a rotor in the embodiment of the invention;

FIG. 3A is a schematic view that shows a state where a magnetic flux passes in the rotor in the embodiment of the invention;

FIG. 3B is a graph that shows the result obtained by calculating the amplitude of a magnetic flux that links with a rotor coil while varying the width θ of the rotor coil in the circumferential direction in the rotary electric machine shown in FIG. 2;

FIG. 4 is a block diagram that shows the configuration of a controller in the embodiment of the invention;

FIG. 5A is a time chart that shows an example of temporal variations in stator currents using a d-axis current command value Id*, a superimposed q-axis current command value Iqsum* and each phase current in the embodiment of the invention;

FIG. 5B is a time chart that shows a temporal variation in rotor magnetomotive force and that corresponds to FIG. 5A;

FIG. 5C is a time chart that shows a temporal variation in motor torque and that corresponds to FIG. 5A;

FIG. 6A is a schematic view that shows a state where magnetic fluxes pass through the stator and the rotor when q-axis current is a set value in the embodiment of the invention;

FIG. 6B is a schematic view that shows a state where magnetic fluxes pass through the stator and the rotor in a first-half period when decreasing pulse current is superimposed on q-axis current;

FIG. 6C is a schematic view that shows a state where magnetic fluxes pass through the stator and the rotor in a second-half period when decreasing pulse current is superimposed on q-axis current.

FIG. 7 is a graph that shows an example of current (stator current) that flow through U-phase stator coils and induced currents (rotor induced currents) that are generated in rotor coils in a rotary electric machine driving system according to a comparative embodiment in which increasing pulse current is superimposed on stator current;

FIG. 8A and FIG. 8B are schematic views of a rotor, showing a change when pulse current is superimposed on q-axis current in a comparative embodiment different from the embodiment of the invention;

FIG. 9 is a view that shows another embodiment of the invention and that corresponds to FIG. 3A;

FIG. 10 is a view that shows an equivalent circuit of rotor coils and rotor auxiliary coils in the embodiment of FIG. 9;

FIG. 11 is a partially schematic cross-sectional view that shows a portion at which a stator faces a rotor in another embodiment of the invention;

FIG. 12 is a schematic view that shows a rotor of another configuration example of the rotary electric machine that constitutes the embodiment of the invention;

FIG. 13 is a schematic view that shows a rotor of another configuration example of the rotary electric machine that constitutes the embodiment of the invention;

FIG. 14 is a schematic view that shows a rotor of another configuration example of the rotary electric machine that constitutes the embodiment of the invention;

FIG. 15 is a schematic view of another configuration example of the rotary electric machine that constitutes the embodiment of the invention when viewed in the direction parallel to the rotation axis of the rotor;

FIG. 16 is a schematic view that shows the rotor of the configuration example of FIG. 15;

FIG. 17 is a schematic view that shows a rotor of another configuration example of the rotary electric machine that constitutes the embodiment of the invention;

FIG. 18 is a schematic view that shows a rotor of another configuration example of the rotary electric machine that constitutes the embodiment of the invention;

FIG. 19 is a schematic view that shows a rotor of another configuration example of the rotary electric machine that constitutes the embodiment of the invention;

FIG. 20 is a schematic view that shows a rotor of another configuration example of the rotary electric machine that constitutes the embodiment of the invention;

FIG. 21 is a view that shows the schematic configuration of a stator and rotor when viewed in the direction parallel to the rotation axis of the rotor in an existing rotary electric machine;

FIG. 22 is a view that shows the schematic configuration of the stator in the rotary electric machine of FIG. 21;

FIG. 23 is a view that shows the schematic configuration of the rotor in the rotary electric machine of FIG. 21; and

FIG. 24 is a graph that shows an example of the correlation between a rotor rotation speed and a motor torque in the same configuration as that of the rotary electric machine of FIG. 21.

### DETAILED DESCRIPTION OF EMBODIMENTS

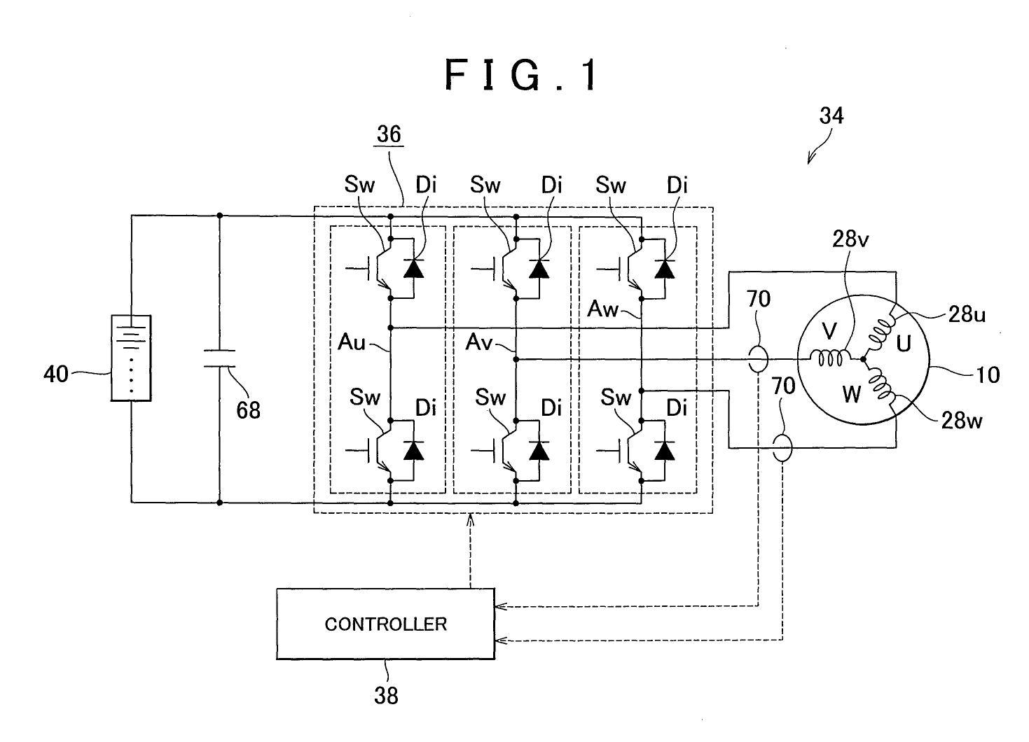

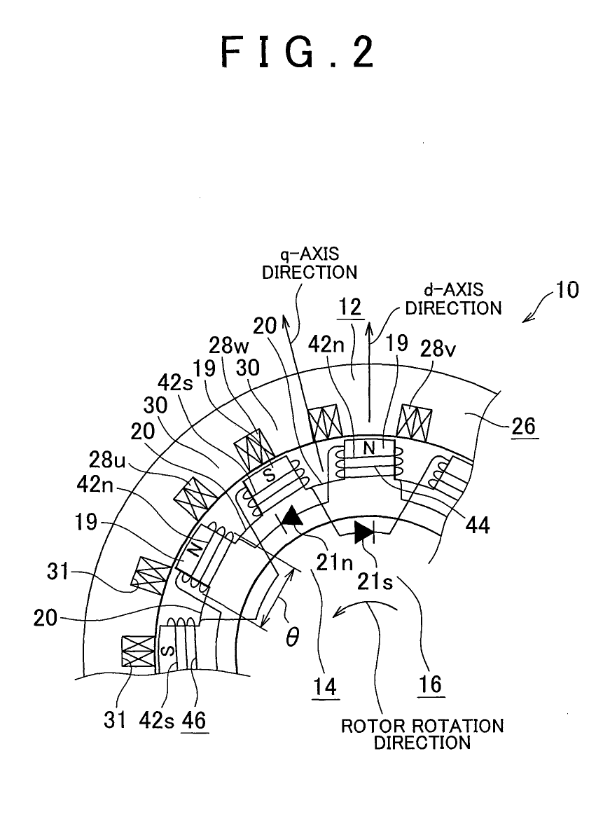

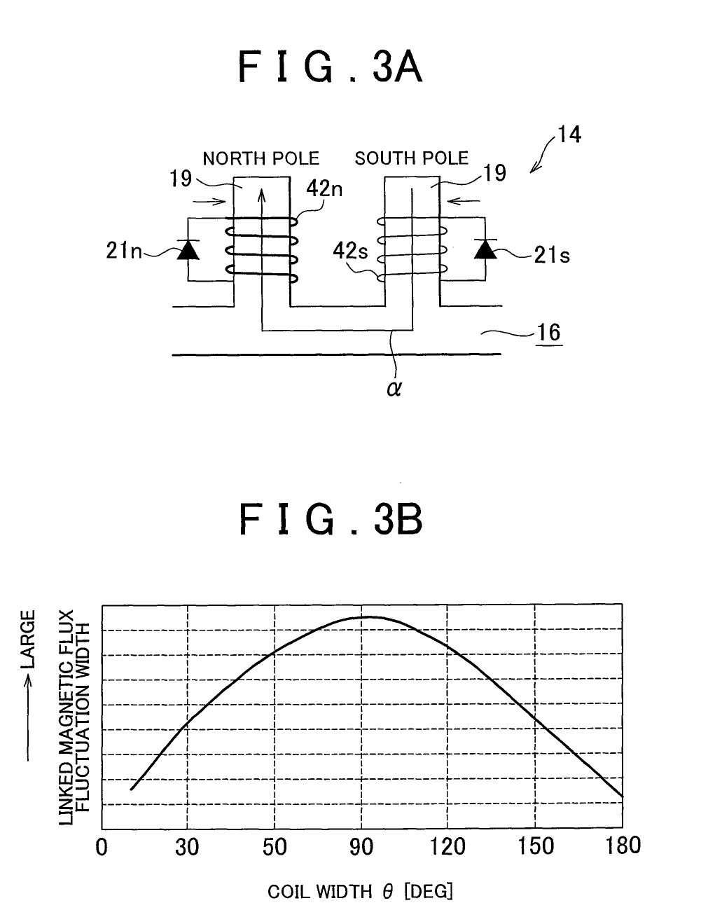

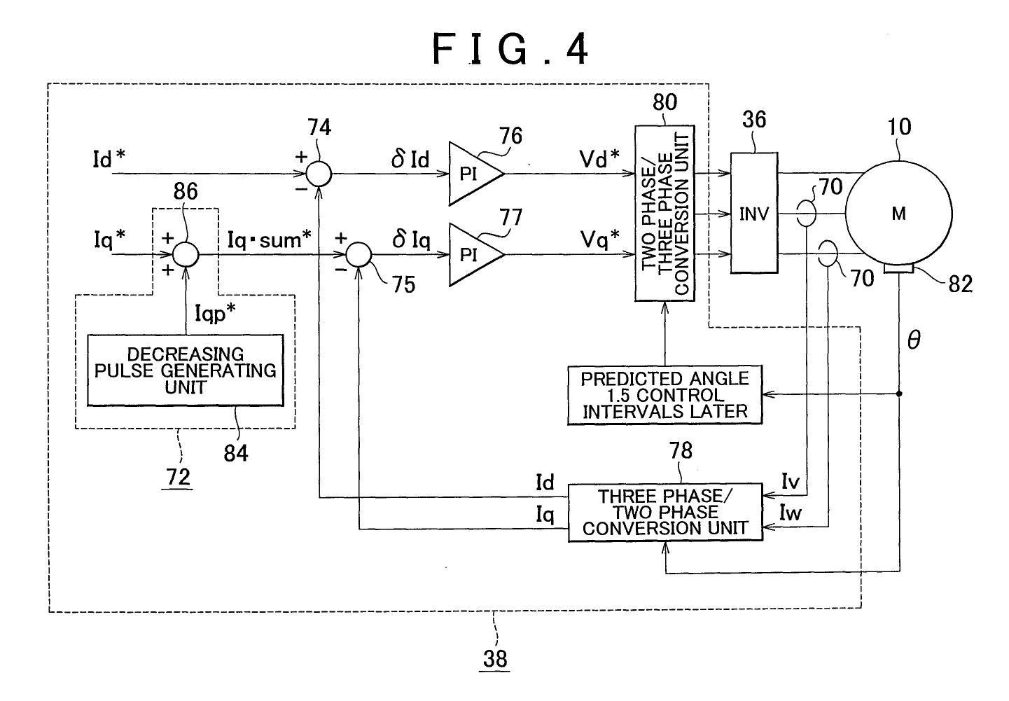

FIG. 1 to FIG. 6 are views that show an embodiment of the invention. FIG. 1 is a view that shows the schematic configuration of a rotary electric machine driving system according to the embodiment. FIG. 2 is a schematic view that partially shows a portion at which a stator faces a rotor in the embodiment. FIG. 3A is a schematic view that shows a state where a magnetic flux passes through the rotor in the embodiment. FIG. 3B is a graph that shows the result obtained by calculating the amplitude of a magnetic flux that links with a rotor coil while varying the width θ of the rotor coil in the circumferential direction in the rotary electric machine shown in FIG. 2. FIG. 4 is a block diagram that shows the configuration of a controller in the embodiment. As shown in FIG. 1, a rotary electric machine driving system 34 according to the embodiment includes a rotary electric machine 10, an inverter 36, a controller 38 and an electrical storage device 40. The inverter 36 is a driving unit that drives the rotary electric machine 10. The controller 38 is a control unit that controls the inverter 36. The electrical storage device 40 is a power source. The rotary electric machine driving system 34 drives the rotary electric machine 10. In addition, as shown in FIG. 2, the rotary electric machine 10, which serves as an electric motor or a generator, includes a stator 12 and a rotor 14. The stator 12 is fixed to a casing (not shown). The rotor 14 is arranged on the inner side of the stator 12 in the radial direction with a predetermined gap so as to face the stator 12, and is rotatable with respect to the stator 12. Note that the “radial direction” means a radiation direction perpendicular to the rotation axis of the rotor (hereinafter, unless otherwise specified, the meaning of the “radial direction” is the same).

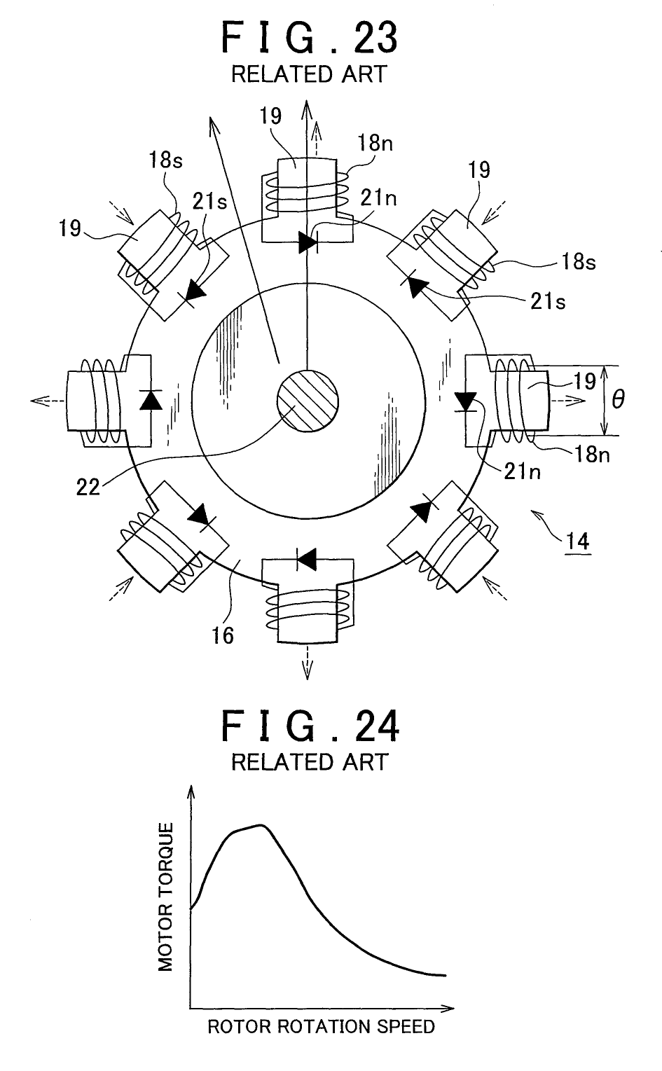

In addition, the stator 12 includes a stator core 26 and multi-phase (more specifically, for example, three U-phase, V-phase and W-phase) stator coils 28u, 28v and 28w. The stator core 26 is made of a magnetic material. The stator coils 28u, 28v and 28w are arranged on the stator core 26. Teeth 30 are arranged at multiple portions of the stator core 26 in the circumferential direction. The teeth 30 are a plurality of stator teeth that protrude toward the inner side in the radial direction (toward the rotor 14 (FIG. 23)). A slot 31, which is a stator slot, is formed between any adjacent teeth 30. Note that the “circumferential direction” means a direction along the circle drawn about the rotation central axis of the rotor (hereinafter, unless otherwise specified, the meaning of the “circumferential direction” is the same).

That is, the plurality of teeth 30 that protrude toward the inner side in the radial direction (toward the rotor 14) are arranged on the inner peripheral surface of the stator core 26 at intervals along the circumferential direction around the rotation central axis that is the rotation axis of the rotor 14, and the slots 31, each of which is formed between any adjacent teeth 30, are formed at intervals in the circumferential direction. That is, the stator core 26 has a plurality of slots 31 that are formed at intervals in the circumferential direction around the rotation axis of the rotor 14.

The three-phase stator coils 28u, 28v and 28w are wound around the corresponding teeth 30 of the stator core 26 via the slots 31 by concentrated short pitch winding. In this way, the stator coils 28u, 28v and 28w are wound around the corresponding teeth 30 to constitute magnetic poles. Then, multi-phase alternating currents are passed through the multi-phase stator coils 28u, 28v and 28w to magnetize the teeth 30 aligned in the circumferential direction. By so doing, revolving magnetic fields that revolve in the circumferential direction may be generated in the stator 12. Note that the stator coils are not limited to the configuration that the stator coils are wound around the corresponding teeth of the stator in this way; the stator coils may be wound around the stator core other than the teeth of the stator.

The revolving magnetic fields formed in the teeth 30 are applied to the rotor 14 from the distal end surfaces of the teeth 30. In the example shown in FIG. 2, one pole pair is formed of the three teeth 30 around which the three-phase (U-phase, V-phase and W-phase) stator coils 28u, 28v and 28w are respectively wound.

In addition, the rotor 14 includes a rotor core 16 made of a magnetic material and a plurality of rotor coils 42n and 42s. Teeth 19 are provided at multiple portions of the outer peripheral surface of the rotor core 16 in the circumferential direction so as to protrude toward the outer side in the radial direction (toward the stator 12), and are arranged at intervals along the outer peripheral surface of the rotor core 16. The teeth 19 are a plurality of magnetic pole portions (protrusions and salient poles) and are rotor teeth. The teeth 19 face the stator 12. In addition, slots 20, each of which is a rotor slot between any adjacent teeth 19 of the rotor core 16, are formed at intervals in the circumferential direction. That is, the rotor core 16 has the plurality of slots 20 that are formed at intervals in the circumferential direction around the rotation axis of the rotor 14.

Because of the teeth 19, magnetic resistances in the case where magnetic fluxes pass from the stator 12 (teeth 30) vary with the rotation direction of the rotor 14. Magnetic resistance is low at the position of each of the teeth 19, and magnetic resistance is high at the position between any adjacent teeth 19. Then, the rotor coils 42n and 42s are wound around these teeth 19 such that the rotor coils 42n and the rotor coils 42s are alternately aligned in the circumferential direction. Here, the winding central axis of each of the rotor coils 42n and 42s coincides with the radial direction.

In addition, the plurality of first rotor coils 42n are respectively wound around the every other teeth 19 in the circumferential direction of the rotor 14 by concentrated winding, and the plurality of second rotor coils 42s are respectively wound around the other teeth 19 by concentrated winding. The other teeth 19 are adjacent to the teeth 19 around which the first rotor coils 42n are wound, and are the every other teeth 19 in the circumferential direction. In addition, diodes 21n and 21s are respectively connected to a first rotor coil circuit 44 and a second rotor coil circuit 46. The first rotor coil circuit 44 includes the plurality of first rotor coils 42n. The second rotor coil circuit 46 includes the plurality of second rotor coils 42s. That is, the plurality of first rotor coils 42n arranged alternately in the circumferential direction of the rotor 14 are electrically connected in series with one another and are connected endlessly, and the diode 21n is connected in series with each of the first rotor coils 42n at a portion between any two of the plurality of first rotor coils 42n to thereby constitute the first rotor coil circuit 44. The diode 21n is a rectifier unit (rectifier element), and is a first diode. The first rotor coils 42n are wound around the teeth 19 that function as the same magnetic poles (north poles).

In addition, the plurality of second rotor coils 42s are electrically connected in series with one another and are endlessly connected, and the diode 21s is connected in series with each of the second rotor coils 42s at a portion between any two of the plurality of second rotor coils 42s to thereby constitute the second rotor coil circuit 46. The diode 21s is a rectifier unit (rectifier element), and is a second diode. The second rotor coils 42s are wound around the teeth 19 that function as the same magnetic poles (south poles). In addition, the rotor coils 42n and 42s that are respectively wound around any adjacent teeth 19 (which form magnets having different magnetic poles) in the circumferential direction are electrically isolated from each other. In this way, the rotor coils 42n and 42s are wound at multiple portions of the outer peripheral portion of the rotor core 16 in the circumferential direction so as to be respectively partially arranged in the corresponding slots 20.

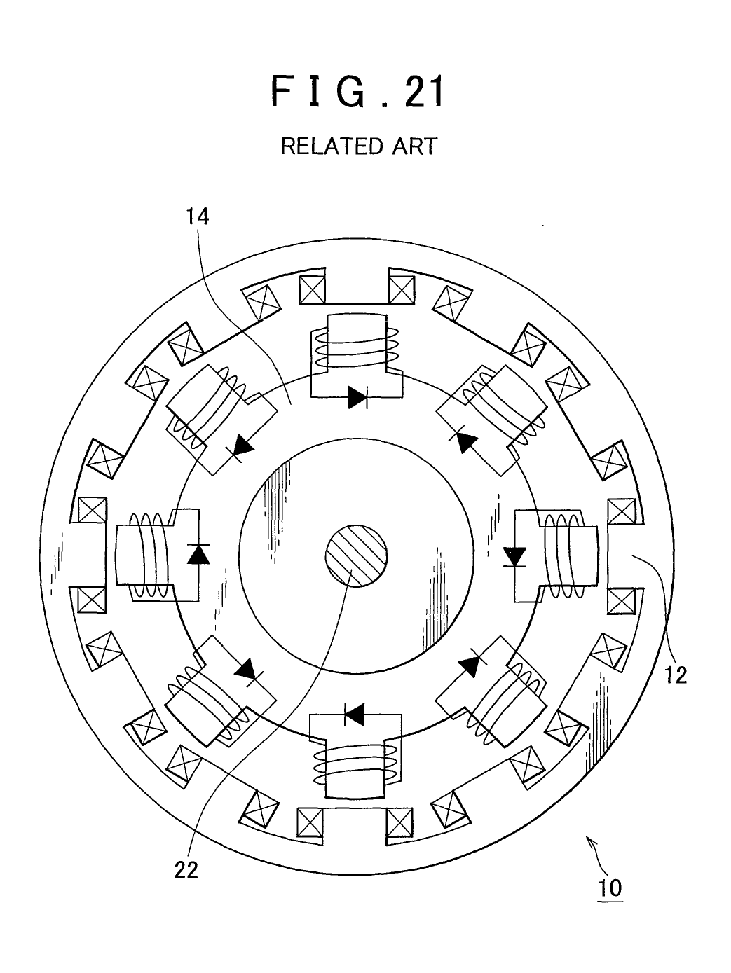

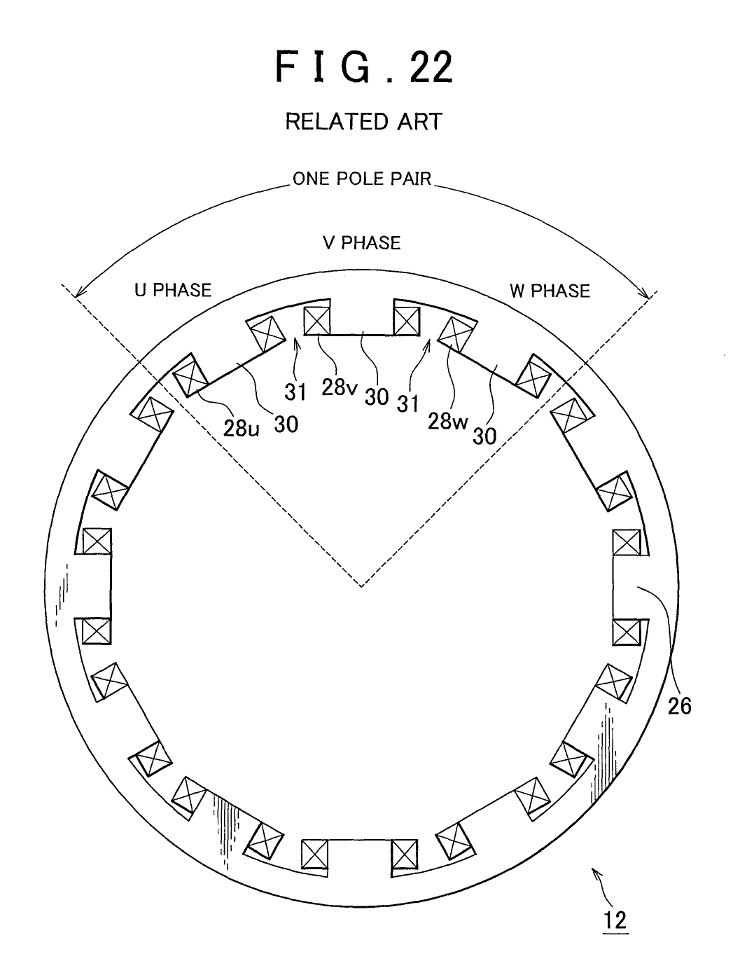

In addition, the rectification directions in which currents flowing through the rotor coils 42n and 42s are respectively rectified by the diodes 21n and 21s are opposite so as to form magnets having different magnetic poles in the any adjacent teeth 19 of the rotor 14 in the circumferential direction. That is, the diodes 21n and 21s are respectively connected to the rotor coils 42n and 42s in mutually opposite directions such that the directions of currents respectively flowing through any adjacent two of the rotor coils 42n and 42s in the circumferential direction of the rotor 14 (the rectification directions of the respective diodes 21n and 21s), that is, the forward directions, are opposite to each other. Then, the diodes 21n and 21s respectively rectify currents that flow through the corresponding rotor coils 42n and 42s because of induced electromotive forces generated by revolving magnetic fields that are generated by the stator 12 and that include space harmonics. By so doing, the phases of currents flowing through any adjacent two of the rotor coils 42n and 42s in the circumferential direction of the rotor 14 are alternately varied between an A phase and a B phase. The A phase is to generate the north pole at the distal end side of a corresponding one of the teeth 19. The B phase is to generate the south pole at the distal end side of a corresponding one of the teeth 19. That is, the rectifier elements provided for the rotor 14 are the diode 21n, which is a first rectifier element, and the diode 21s, which is a second rectifier element. The diode 21n and the diode 21s are respectively connected to the corresponding rotor coils 42n and 42s. In addition, the diodes 21n and 21s respectively independently rectify currents flowing through the corresponding rotor coils 42n and 42s because of generated induced electromotive forces, and vary the magnetic characteristics of the teeth 19 at multiple portions in the circumferential direction alternately in the circumferential direction. The magnetic characteristics of the teeth 19 are generated by currents flowing through the respective rotor coils 42n and 42s. In this way, the plurality of diodes 21n and 21s vary the magnetic characteristics alternately in the circumferential direction. The magnetic characteristics are respectively generated in the plurality of teeth 19 by induced electromotive forces generated in the rotor coils 42n and 42s. That is, the diodes 21n and 21s are connected to the corresponding rotor coils 42n and 42s, and vary the magnetic characteristics of the respective rotor coils 42n and 42s alternately in the circumferential direction among the plurality of rotor coils 42n and 42s. With this configuration, different from the case of the configuration shown in FIG. 21 to FIG. 23, the number of the diodes 21n and 21s may be reduced to two, so the coil structure of the rotor 14 may be simplified. In addition, the rotor 14 is concentrically fixed to the outer side of a rotary shaft 22 (see FIG. 21, FIG. 23, and the like, and not shown in FIG. 2) in the radial direction. The rotary shaft 22 is rotatably supported by a casing (not shown). Note that, in the present embodiment, the rectifier elements are connected to the corresponding rotor coils 42n and 42s; however, in the aspect of the invention, the rectifier unit that alternately varies the magnetic characteristics of the rotor coils in the circumferential direction among the plurality of rotor coils just needs to be connected to the rotor coils, and the rectifier unit may use a configuration other than the rectifier elements. Note that the rotor coils 42n and 42s may be wound around the corresponding teeth 19 via insulators, or the like, made of resin, or the like, having electrical insulation properties.

In addition, the width θ of each of the rotor coils 42n and 42s in the circumferential direction of the rotor 14 is set so as to be shorter than the width corresponding to 180° in the electric angle of the rotor 14, and the rotor coils 42n and 42s are respectively wound around the teeth 19 by short pitch winding. More desirably, the width θ of each of the rotor coils 42n and 42s in the circumferential direction of the rotor 14 is equal to or substantially equal to the width corresponding to 90° in the electric angle of the rotor 14. The width θ of each of the rotor coils 42n and 42s here may be expressed by the center width of the cross section of each of the rotor coils 42n and 42s in consideration of the cross-sectional area of each of the rotor coils 42n and 42s. That is, the width θ of each of the rotor coils 42n and 42s may be expressed by the mean value of the width of the inner peripheral surface and the width of the outer peripheral surface of each of the rotor coils 42n and 42s. Note that the electric angle of the rotor 14 is expressed by a value that is obtained by multiplying the mechanical angle of the rotor 14 by the number p of pole pairs of the rotor 14 (electric angle=mechanical angle×p). Therefore, the width θ of each of the rotor coils 42n and 42s in the circumferential direction satisfies the following mathematical expression (1) where the distance from the rotation central axis of the rotor 14 to each of the rotor coils 42n and 42s is r.

0<π×r/p (1)

The reason why the width θ is restricted by the mathematical expression (1) will be described in detail later.

In addition, as shown in FIG. 1, the electrical storage device 40 is provided as a direct-current power supply. The electrical storage device 40 is chargeable and dischargeable, and is, for example, formed of a secondary battery. The inverter 36 includes three U-phase, V-phase and W-phase arms Au, Av and Aw. In each of the three-phase arms Au, Av and Aw, two switching elements Sw are connected in series with each other. The switching elements Sw are transistors, IGBTs, or the like. In addition, a diode Di is connected in antiparallel with each of the switching elements Sw. Furthermore, the midpoints of the arms Au, Av and Aw are respectively connected to one ends of the corresponding phase stator coils 28u, 28v and 28w that constitute the rotary electric machine 10. Among the stator coils 28u, 28v and 28w, the stator coils of the same phase are connected in series with one another, and the stator coils 28u, 28v and 28w of the different phases are connected to one another at a neutral point.

In addition, the positive electrode side and negative electrode side of the electrical storage device 40 are respectively connected to the positive electrode side and negative electrode side of the inverter 36, and a capacitor 68 is connected in parallel with the inverter 36 between the electrical storage device 40 and the inverter 36. The controller 38, for example, calculates the torque target of the rotary electric machine 10 in response to an acceleration command signal input from an accelerator pedal sensor (not shown), or the like, of a vehicle, and then controls switching operations of the switching elements Sw on the basis of a current command value according the torque target, and the like. Signals that indicate current values detected by current sensors 70 provided for at least two-phase stator coils (for example, 28u and 28v) among the three-phase stator coils and a signal that indicates the rotation angle of the rotor 14 of the rotary electric machine 10, detected by a rotation angle detecting unit 82 (FIG. 4), such as a resolver, are input to the controller 38. The controller 38 includes a microcomputer that has a CPU, a memory, and the like. The controller 38 controls switching of the switching elements Sw of the inverter 36 to control the torque of the rotary electric machine 10. The controller 38 may be formed of a plurality of controllers divided function by function.

The thus configured controller 38 is able to convert direct-current power from the electrical storage device 40 to three U-phase, V-phase and W-phase alternating-current power by the switching operations of the switching elements Sw that constitute the inverter 36 to supply the three-phase stator coils 28u, 28v and 28w with powers of the corresponding phases. With the thus configured controller 38, it is possible to control the torque of the rotor 14 (FIG. 2) by controlling the phases (advances) of alternating currents flowing through the stator coils 28u, 28v and 28w.

In addition, with the rotary electric machine 10 shown in FIG. 2, induced currents are generated in the rotor coils 42n and 42s by the revolving magnetic fields to thereby make it possible to cause the rotor 14 to generate torque. The revolving magnetic fields are generated by the stator 12, and include space harmonics. That is, the distribution of magnetomotive forces that cause the stator 12 to generate revolving magnetic fields is not a sinusoidal distribution (of only the fundamental) but includes harmonic components because of arrangement of the three-phase stator coils 28u, 28v and 28w and the shape of the stator core 26 due to the teeth 30 and the slots 31. Particularly, in concentrated winding, the three-phase stator coils 28u, 28v and 28w do not overlap one another, so the amplitude level of harmonic components that occur in the magnetomotive force distribution of the stator 12 increases. For example, when the stator coils 28u, 28v and 28w are formed by three-phase concentrated winding, the amplitude level of spatial secondary component that is the (temporal) tertiary component of input electrical frequency increases as harmonic components. The harmonic components that occur in magnetomotive forces because of arrangement of the stator coils 28u, 28v and 28w and the shape of the stator core 26 in this way are called space harmonics.

In addition, as three-phase alternating currents are passed through the three-phase stator coils 28u, 28v and 28w to cause the revolving magnetic fields (fundamental components) formed in the teeth 30 to be applied to the rotor 14, the teeth 19 are attracted by the revolving magnetic fields of the teeth 30 such that the magnetic resistance of the rotor 14 reduces. By so doing, torque (reluctance torque) acts on the rotor 14.

Furthermore, as the revolving magnetic fields that are formed in the teeth 30 and that include space harmonic components link with the rotor coils 42n and 42s of the rotor 14, magnetic flux fluctuations in frequency different from the rotation frequency (the fundamental components of the revolving magnetic fields) of the rotor 14 occur in the rotor coils 42n and 42s because of the space harmonic components. Because of the magnetic flux fluctuations, induced electromotive forces are generated in the rotor coils 42n and 42s. With the generated induced electromotive forces, currents flowing through the rotor coils 42n and 42s are respectively rectified by the diodes 21n and 21s so as to have a one-way direction (direct current). Then, the teeth 19 that are rotor teeth are magnetized as direct currents rectified by the diodes 21n and 21s flow through the rotor coils 42n and 42s. By so doing, each of the teeth 19 functions as a magnets having a fixed magnetic pole (any one of the north pole and the south pole). As described above, the rectification directions in which currents flowing through the rotor coils 42n and 42s are rectified by the diodes 21n and 21s are opposite to each other, so magnets generated in the respective teeth 19 are such that the north poles and the south poles are alternately arranged in the circumferential direction. Then, the magnetic fields of the teeth 19 (magnets having fixed magnetic poles) interact with the revolving magnetic fields (fundamental components) generated by the stator 12 to generate attraction and repulsion actions. Torque (which corresponds to magnet torque) may be applied to the rotor 14 even by the electromagnetic interaction (attraction and repulsion actions) between the revolving magnetic fields (fundamental components) generated by the stator 12 and the magnetic fields of the teeth 19 (magnets), and the rotor 14 is driven for rotation in synchronization with the revolving magnetic fields (fundamental components) generated by the stator 12. In this way, the rotary electric machine 10 is able to function as an electric motor that utilizes electric power supplied to the stator coils 28u, 28v and 28w to cause the rotor 14 to generate power (mechanical power).

In this case, in the rotor 14, as shown by the schematic view in FIG. 3A, the different diodes 21n and 21s are respectively connected to the rotor coils 42n and 42s that are respectively wound around any adjacent teeth 19 in the circumferential direction of the rotor 14. The revolving magnetic fields that are generated by the stator 12 (FIG. 2) and that include harmonics link with the rotor coils 42n and 42s. By so doing, induced currents of which the directions are regulated by the diodes 21n and 21s are induced in the rotor coils 42n and 42s, and the teeth 19 are magnetized as different magnetic pole portions between any adjacent teeth 19. In this case, a magnetic flux caused by induced current passes through the teeth 19 and a portion of the rotor core 16 other than the teeth 19 in the direction indicated by the arrow α in FIG. 3A.

In addition, the rotary electric machine driving system 34 shown in FIG. 1 is, for example, mounted on a hybrid vehicle, a fuel-cell vehicle, an electric vehicle, or the like, as a vehicle driving power generating device and is used. The hybrid vehicle includes an engine and a drive motor as driving sources. Note that it is also applicable that a DC/DC converter that is a voltage conversion unit is connected between the electrical storage device 40 and the inverter 36 and the voltage of the electrical storage device 40 is stepped up and supplied to the inverter 36.

In addition, the controller 38 of the rotary electric machine driving system 34 has a decreasing pulse superimposing unit 72 (FIG. 4). The decreasing pulse superimposing unit 72 superimposes decreasing pulse current for a pulse-shaped decrease on a q-axis current command for passing currents through the stator coils 28u, 28v and 28w such that field magnetic fluxes are generated in directions advanced by 90 degrees in electric angle with respect to the magnetic pole directions that are the winding central axis directions of the respective rotor coils 42n and 42s. This will be described in detail with reference to FIG. 4. FIG. 4 is a view that shows the configuration of an inverter control unit in the controller 38. The controller 38 includes a current command calculation unit (not shown), the decreasing pulse superimposing unit 72, subtracting units 74 and 75, PI operation units 76 and 77, a three phase/two phase conversion unit 78, a two phase/three phase conversion unit 80, the rotation angle detecting unit 82, a PWM signal generating unit (not shown) and a gate circuit (not shown).

The current command calculation unit calculates current command values Id* and Iq* corresponding to the d axis and the q axis in accordance with a prepared table, and the like, on the basis of the torque command value of the rotary electric machine 10, calculated in response to an acceleration command input from a user. Here, the d axis means a magnetic pole direction that is the winding central axis direction of each of the rotor coils 42n and 42s in the circumferential direction of the rotary electric machine 10, and the q axis means a direction advanced by 90 degrees in electric angle with respect to the d axis. For example, when the rotation direction of the rotor 14 is defined as shown in FIG. 2, the d-axis direction and the q-axis direction are defined by the relationship as indicated by the arrows in FIG. 2. In addition, the current command values Id* and Iq* are respectively a d-axis current command value that is a command value for a d-axis current component and a q-axis current command value that is a command value for a q-axis current component. Such the d axis and the q axis are used to make it possible to determine currents to be passed through the stator coils 28u, 28v and 28w by vector control.

The three phase/two phase conversion unit 78 calculates a d-axis current value Id and a q-axis current value Iq, which are two-phase currents, from the rotation angle θ of the rotary electric machine 10, detected by the rotation angle detecting unit 82 provided for the rotary electric machine 10, and the two-phase currents (for example, V-phase and W-phase currents Iv and Iw) detected by the current sensors 70. Note that the reason why only two-phase currents are detected by the current sensors 70 is because the sum of the two-phase currents (the d-axis current value Id and the q-axis current value Iq) is 0 and, therefore, the other phase current may be calculated. However, it is also applicable that the U-phase, V-phase and W-phase currents are detected and then the d-axis current value Id and the q-axis current value Iq are calculated from those current values.

The decreasing pulse superimposing unit 72 has a decreasing pulse generating unit 84 and an adding unit 86. The decreasing pulse generating unit 84 generates decreasing pulse current. The adding unit 86 superimposes a decreasing pulse current Iqp* on a q-axis current command value Iq* at set intervals, that is, adds the decreasing pulse current Iqp* to the q-axis current command value Iq* at set intervals, and then outputs a superimposed q-axis current command value Iqsum* after the addition to the corresponding subtracting unit 75. In addition, the subtracting unit 74 corresponding to the d axis obtains a deviation δId between the d-axis current command value Id* and the d-axis current Id converted by the three phase/two phase conversion unit 78 and then inputs the deviation δId to the PI operation unit 76 corresponding to the d axis.

In addition, the subtracting unit 75 corresponding to the q axis obtains a deviation δIq between the superimposed q-axis current command value Iqsum* and the q-axis current Iq converted by the three phase/two phase conversion unit 78 and then inputs the deviation δIq to the PI operation unit 77 corresponding to the q axis. The PI operation units 76 and 77 respectively perform PI operation over the input deviations δId and δIq by a predetermined gain to obtain control deviations and then calculate a d-axis voltage command value Vd* and a q-axis voltage command value Vq* corresponding to the control deviations.

The two phase/three phase conversion unit 80 converts the voltage command values Vd* and Vq* input from the PI operation units 76 and 77 to three U-phase, V-phase and W-phase voltage command values Vu, Vv and Vw using a predicted angle that is obtained from the rotation angle θ of the rotary electric machine 10 and that is predicted as a position 1.5 control intervals later. The voltage command values Vu, Vv and Vw are converted to PWM signals by a PWM signal generating unit (not shown), and the PWM signals are output to the gate circuit (not shown). The gate circuit selects the switching elements Sw to which control signals are applied to thereby control on/off states of the switching elements Sw. In this way, the controller 38 converts stator currents flowing through the stator coils 28u, 28v and 28w into a dq-axis coordinate system to obtain a d-axis current component and a q-axis current component, and controls the inverter 36 so as to be able to obtain the respective phase stator currents corresponding to the target torque through vector control including feedback control.

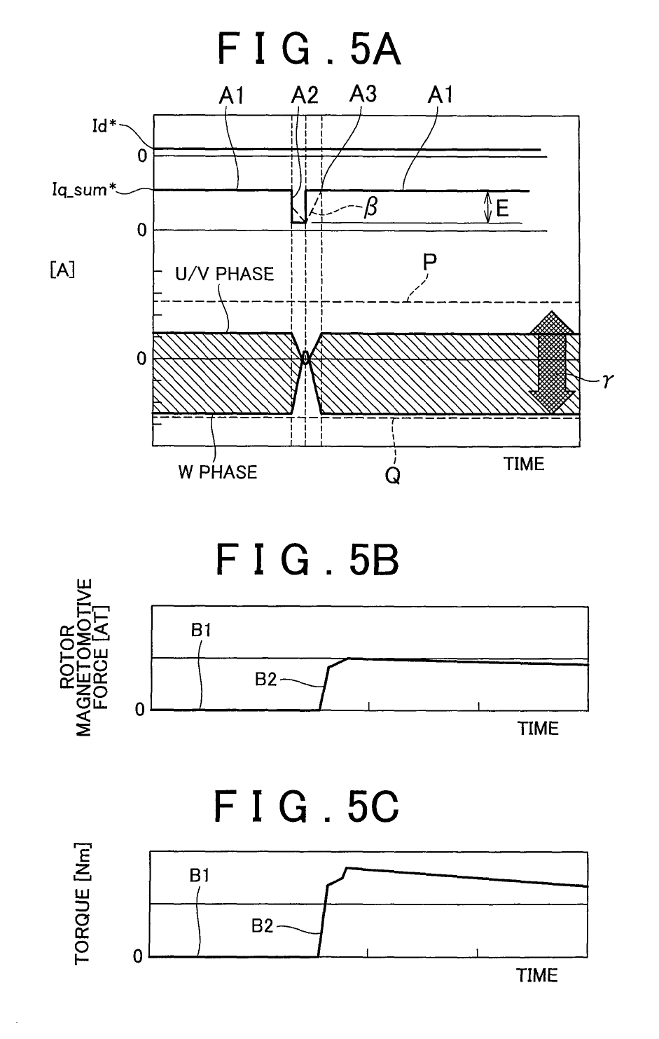

FIG. 5A is a time chart that shows an example of temporal variations in stator currents using a d-axis current command value Id*, a superimposed q-axis current command value Iqsum* and each phase current in the embodiment. FIG. 5B is a time chart that shows a temporal variation in rotor magnetomotive force and that corresponds to FIG. 5A. FIG. 5C is a time chart that shows a temporal variation in motor torque and that corresponds to FIG. 5A. Note that FIG. 5A, FIG. 5B and FIG. 5C show simulation results while an extremely short period of time is temporally expanded, that is, expanded in the horizontal direction in the drawings. Thus, actually, the U-phase, V-phase and W-phase currents respectively form sinusoidal waves when the rotary electric machine is driven; however, in FIG. 5A, those phase currents are shown linearly before and after pulse current is superimposed. Note that, in the following description, like reference numerals denote the same components as the elements shown in FIG. 1 to FIG. 4.

As shown in FIG. 5A, the decreasing pulse superimposing unit 72 shown in FIG. 4 superimposes decreasing pulse current on only the q-axis current command value Iq*. The d-axis current command value Id* is a constant value calculated in correspondence with a torque command. In this way, a current command that decreases and then increases in a pulse-shaped manner at set intervals is superimposed on the q-axis current command value Iq* by the decreasing pulse superimposing unit 72. Note that, even when pulse current is instructed as a rectangular waveform as shown in FIG. 5A, pulse current may actually have a pulse-shaped form that combines curves as indicated by the broken lines β because of a delay in response. In addition, the pulse-shaped waveform of the decreasing pulse current may be any of a rectangular wave, a triangular wave and a waveform formed from a plurality of curves and/or lines into a projecting shape.

When the decreasing pulse current is superimposed in this way, for example, the absolute value of current decreases even when the maximum current flows through one-phase stator coil, equal currents respectively flow through the remaining two-phase stator coils and the sum of the equal currents flowing through the remaining two-phase stator coils flows through the one-phase stator coil. For example, FIG. 5A shows the case where the maximum current flows through the W-phase stator coils 28w, equal currents respectively flow through the remaining two U-phase and V-phase stator coils 28u and 28v and the sum of the equal currents flowing through the remaining two-phase stator coils 28u and 28v flows through the W-phase stator coils 28w. In this case, the arrow y indicates a current limit range, and the broken lines P and Q are the allowable current limits required in terms of design. That is, current values are required to fall between the broken lines P and Q on the basis of the relationship of the components, such as capacity, of the inverter 36. Then, a current value that flows through the W-phase stator coils 28w is located near one of the allowable current limits. In this case, the absolute value of each phase current value becomes small because of superimposition of decreasing pulse current; however, variations in magnetic fluxes of space harmonic components included in the revolving magnetic fields generated by the stator 12 increase with current variations. Therefore, the rotor magnetomotive force increases as shown in FIG. 5B, and the motor torque increases as shown in FIG. 5C. In addition, the peak of each of positive U-phase and V-phase pulse currents decreases, and the peak of negative W-phase pulse current increases, so each phase current may be caused to fall within the current limit range (range indicated by the arrow y in FIG. 5A).

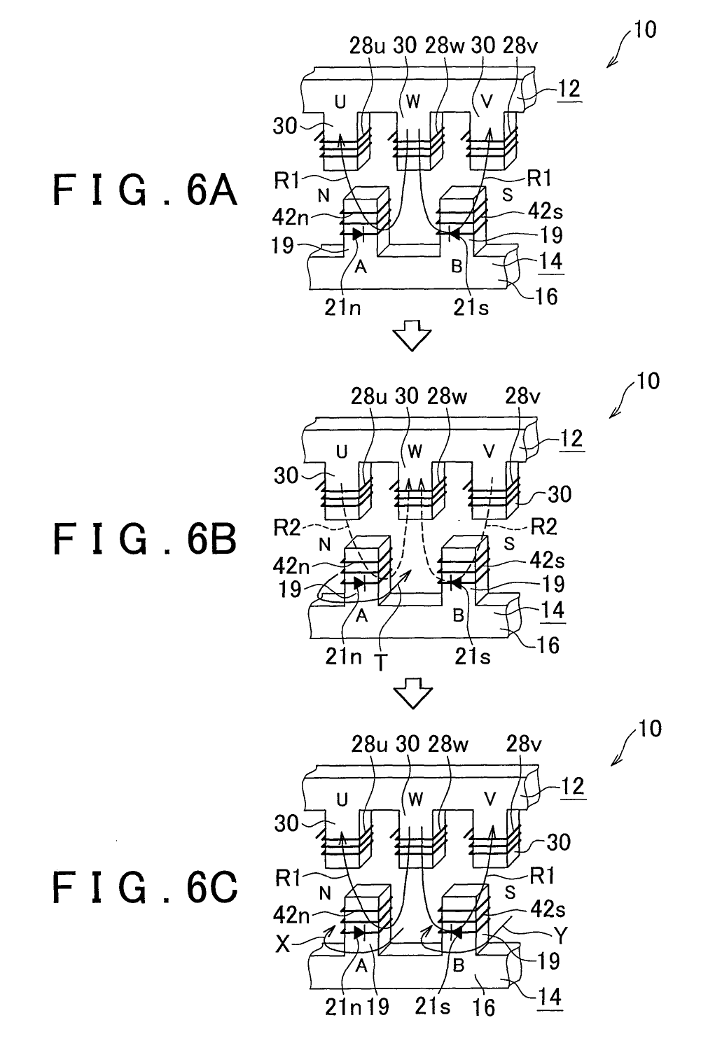

This will be further described in detail with reference to FIG. 6A to FIG. 6C. FIG. 6A to FIG. 6C are schematic views that respectively show a state where magnetic fluxes pass through the stator and the rotor when the q-axis current is a set value, a state where magnetic fluxes pass through the stator and the rotor when decreasing pulse current is superimposed on the q-axis current in a first-half period and a state where magnetic fluxes pass through the stator and the rotor when decreasing pulse current is superimposed on the q-axis current in a second-half period in the embodiment. In each of FIG. 6A to FIG. 6C, the teeth 30 around which the three-phase stator coils 28u, 28v and 28w are wound do not radially face the teeth 19 around which the rotor coils 42n and 42s are wound, so one of the teeth 30 faces the center position between two adjacent teeth 19 in the circumferential direction of the rotor 14. In this state, as indicated by the solid arrows R1 and the broken arrows R2 in FIG. 6A to FIG. 6C, the magnetic fluxes passing through the stator 12 and the rotor 14 are q-axis magnetic fluxes.

FIG. 6A corresponds to the A1 state where the superimposed q-axis current command value Iqsum* is a set value in FIG. 5A. FIG. 6B corresponds to the state where decreasing pulse current is occurring in the superimposed q-axis current command value Iqsum* in a first-half period, that is, the A2 state where Iqsum* steeply decreases, in FIG. 5A. In addition, FIG. 6C corresponds to the state where decreasing pulse current is occurring in the superimposed q-axis current command value Iqsum* in a second-half period, that is, the A3 state where Iqsum* steeply increases, in FIG. 5A.

First, as shown in FIG. 6A, in the state where the superimposed q-axis current command value Iqsum* is a set value before decreasing pulse current occurs, magnetic fluxes pass from the U-phase and V-phase teeth 30 to the W-phase tooth 30 via the upper portions of the teeth 19 of the rotor 14 as indicated by the solid arrows R1. However, in this case, variations in magnetic fluxes due to the fundamental that passes through each of the teeth 30 do not occur, so no rotor magnetomotive force occurs and no motor torque is generated when space harmonics are not taken into consideration as shown at the portion B1 in FIG. 5B and FIG. 5C.

In contrast to this, as shown in FIG. 6B, in the state where decreasing pulse current is occurring in the first-half period, that is, the state where q-axis current steeply decreases, the absolute value of current that flows through each of the stator coils 28u, 28v and 28w varies to decrease, and, apparently, magnetic fluxes pass in the opposite direction because of a change from FIG. 6A as indicated by the broken arrows R2. Note that, for the variations in magnetic fluxes, the signs of the stator current values may be inverted such that the magnetic fluxes actually pass in the direction opposite to that of FIG. 6A. In any case, the magnetic flux passes in the direction to change from the north pole to the south pole in the tooth 19 of “A”, induced current attempts to flow through the rotor coil 42n in the direction to prevent the passage of the magnetic flux, and passage of the induced current in the arrow T direction in FIG. 6B is not blocked by the diode 21n. In contrast to this, the magnetic flux passes in the direction to enhance the south pole in the tooth 19 of “B”, and induced current attempts to flow through the rotor coil 42s in the direction to prevent the passage of the magnetic flux, that is, the direction to change the tooth 19 of “B” into the north pole; however, the flow of induced current in that direction is blocked by the diode 21s, so current does not flow in the region of “B”.

Subsequently, as shown in FIG. 6C, in a state where decreasing pulse current is occurring in the second-half period, that is, in a state where q-axis current steeply increases, the absolute value of current that flows through each of the stator coils 28u, 28v and 28w varies to increase and then magnetic fluxes pass in the direction opposite to that of FIG. 6B, as indicated by the solid arrows R1. In this case, the magnetic flux passes in the direction to enhance the north pole in the tooth 19 of “A” and induced current attempts to flow through the rotor coil 42n in the direction to prevent the passage of the magnetic flux, that is, the direction to change the tooth 19 of “A” into the south pole (X direction opposite to that of the diode 21n); however, current has already been flowing in FIG. 6B, so the current gradually reduces for at least a certain period of time but flows in the direction opposite to the X direction. In addition, the magnetic flux passes in the direction to change the south pole to the north pole in the tooth 19 of “B”, induced current attempts to flow through the rotor coil 42s in the direction to prevent the passage of the magnetic flux, and the flow of the induced current in the arrow Y direction in FIG. 6C is not blocked by the diode 21s. As a result, as shown by the portion B2 in FIG. 5B and FIG. 5C, rotor magnetomotive force increases because of superimposition of decreasing pulse, and the motor torque increases.

In addition, as the decreasing pulse current becomes 0 and returns to the state of FIG. 6A again, currents flowing through the rotor coils 42n and 42s gradually decrease; however, the decreasing pulse current is periodically superimposed to thereby make it possible to obtain the effect of increasing the torque. Note that, in the above description, decreasing pulse current is superimposed when current that flows through the W-phase stator coils 28w is maximal; however, this also applies to the case of U phase or V phase.

With the above rotary electric machine driving system, it is possible to implement the rotary electric machine that is able to increase torque even in a low rotation speed range while preventing excessive currents from flowing through all the stator coils 28u, 28v and 28w. For example, even when the absolute value of current that flows through the W-phase stator coils 28w is higher than the absolute value of each of currents that flow through the other two U-phase and V-phase stator coils 28u and 28v before pulse current is superimposed on current that flows through the W-phase stator coils 28w, it is possible to increase induced currents that are generated in the rotor coils 42n and 42s while decreasing the absolute values of currents flowing through the stator coils of all the phases in pulse-shaped manner by superimposing decreasing pulse current. Therefore, it is possible to increase the torque of the rotary electric machine 10 in a low rotation speed range while suppressing the peaks of stator currents that are currents to be passed through all the stator coils 28u, 28v and 28w. In addition, it is not necessary to provide magnets for the rotor 14, so a magnetless and high-torque configuration may be achieved.

In addition, as shown in FIG. 5A, decreasing pulse current is superimposed on the q-axis current command to decrease the absolute value of current flowing through one phase, for example, the W-phase, stator coils 28w, significantly in a pulse-shaped manner; however, the peak edge of current varying in a pulse-shaped manner in this way is not limited so as to be located around 0. For example, it is also applicable that, after negative current flowing through the W-phase stator coils 28w increases to around 0, the width of decrease E (FIG. 5A) in the decreasing pulse current of the superimposed q-axis current command Iqsum* may be increased so as to increase toward the positive side. In this case as well, it is possible to increase the amounts of variations in q-axis magnetic fluxes due to space harmonics without excessively increasing stator currents, and the torque may be increased.

In contrast to this, in the case of the synchronous machine described in JP-A-2007-185082, electromagnets are formed of the rotor using pulse current; however, the rotor coils are provided at the outer peripheral portion of the rotor so as to span in the radial direction, and one rectifier element is connected to each rotor coil to form two different magnetic poles at the opposite sides in the radial direction of the rotor. Therefore, induced currents for forming two magnetic poles cancel each other even when pulse is superimposed on q-axis current, so induced currents cannot be generated in the rotor coils. That is, with this configuration, it is impossible to generate torque by superimposing pulse current on the q-axis current.

In addition, in the case of the synchronous machine described in JP-A-2010-98908, increasing pulse current that increases and then decreases in a pulse-shaped manner is superimposed on d-axis current and q-axis current, so the peaks of currents that flow through the stator coils may excessively increase. In addition, in the case of the synchronous machine described in JP-A-2010-110079, for the purpose of implementing the rotary electric machine that is able to increase torque even in a low rotation speed range while preventing excessive currents from flowing through the stator coils, no device for superimposing decreasing pulse current on q-axis current is described.

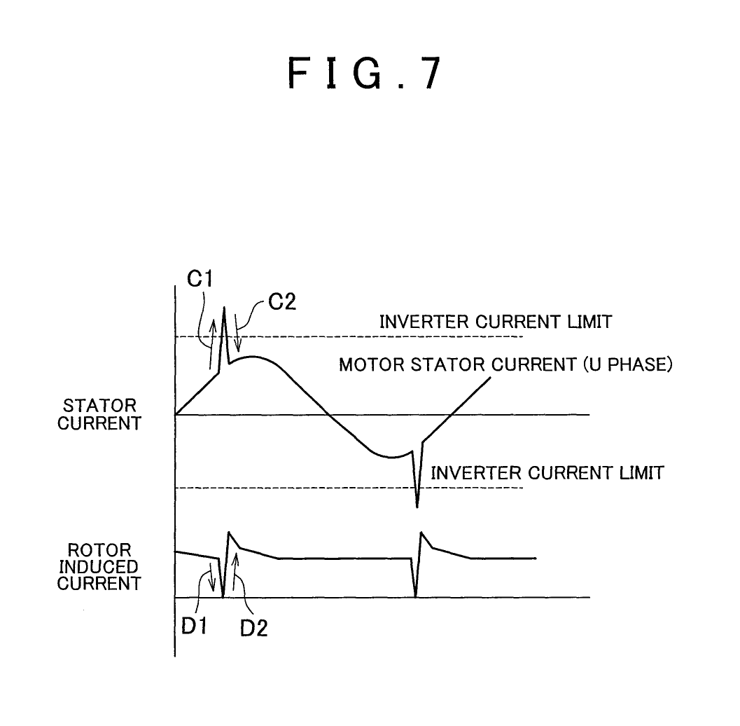

For example, FIG. 7 is a graph that shows an example of current (stator current) flowing through the U-phase stator coils and induced current (rotor induced current) that occurs in the rotor coils in a rotary electric machine driving system according to a comparative embodiment that is different from the embodiment of the invention and in which increasing pulse current is superimposed on stator current. This comparative embodiment differs from the above described embodiment only in that increasing pulse current is superimposed instead of decreasing pulse current. As shown in FIG. 7, in the comparative embodiment, increasing pulse current that increases and then decreases in a pulse-shaped manner is superimposed on sinusoidal stator current. In this case, because stator current steeply increases as indicated by the arrow C1, rotor induced current steeply reduces in accordance with the principle of electromagnetic induction as indicated by the arrow D1. After that, stator current steeply decreases as indicated by the arrow C2, so rotor induced current increases as indicated by the arrow D2. Because of this principle, current that flows through any one of the three-phase stator coils increases. Therefore, large pulse current may be sometimes required to be superimposed in order to generate desired torque. In this case, as in the case of the synchronous machines described in JP-A-2007-185082 and JP-A-2010-98908, increasing pulse current is superimposed on d-axis current. Therefore, there is a possibility that the peak value of current becomes excessive to exceed inverter current limits required in terms of design. Therefore, it may be, for example, necessary to increase the capacity of each switching element of the inverter, leading to an increase in cost or size of a control system, including the inverter. In addition, it is necessary to expand the detection range of each current sensor for current control, so it may lead to an increase in the size of each sensor or a decrease in detection accuracy of each sensor. Therefore, there has been sought to implement a device that is able to increase torque while preventing excessive current peak values.

In contrast to this, according to the present embodiment, it is possible to prevent excessive stator currents, that is, it is possible to prevent excessive peak values of currents, so all the above inconvenience may be eliminated.

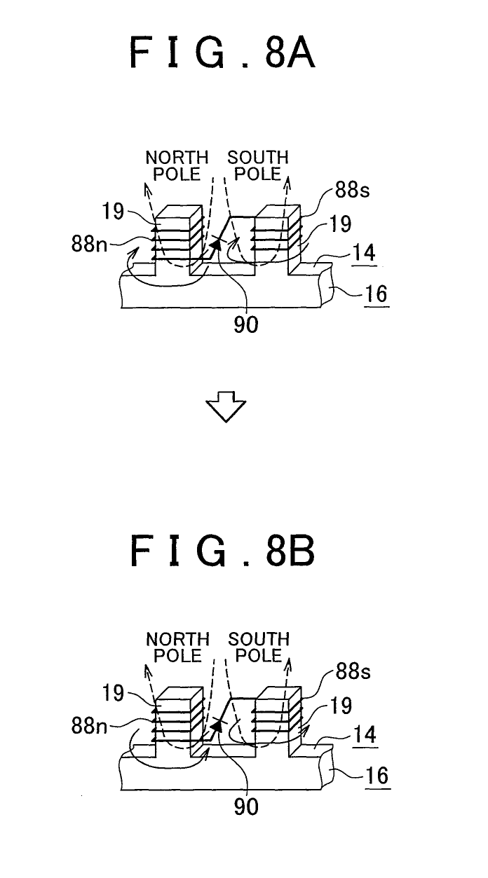

In addition, according to the present embodiment, the rotor coils 42n and 42s are connected to the corresponding diodes 21n and 21s that are rectifier elements of which the forward directions are opposite between any adjacent rotor coils 42n and 42s in the circumferential direction of the rotor 14, and the diodes 21n and 21s rectify currents flowing through the rotor coils 42n and 42s because of the generated induced electromotive forces to vary the phases of currents flowing through any adjacent rotor coils 42n and 42s in the circumferential direction alternately between the A phase and the B phase. In contrast to this, as shown in FIGS. 8A and 8B, a comparative embodiment different from the present embodiment is conceivable. FIG. 8A and FIG. 8B are schematic views of the rotor, showing a change when pulse current is superimposed on q-axis current in the comparative embodiment.

In the comparative embodiment of FIG. 8A and FIG. 8B, rotor coils 88n and 88s are wound at multiple portions of the rotor 14 in the circumferential direction, any adjacent rotor coils 88n and 88s are connected via a diode 90 and the magnetic characteristics of the teeth 19 are alternately varied. The teeth 19 are magnetic pole portions, and the magnetic characteristics of the teeth 19 are generated by currents that flow through the rotor coils 88n and 88s. In this comparative embodiment, when pulse current is superimposed on the q-axis currents to cause the q-axis magnetic fluxes due to space harmonics to pass as indicated by the broken arrows in FIG. 8A and FIG. 8B, currents attempts to flow in the direction to change both the north pole and the south pole into the south pole in FIG. 8A, and the north pole-side and south pole-side currents cancel each other. In addition, even when the q-axis magnetic fluxes pass in the direction opposite to that of FIG. 8A, currents attempt to flow in the direction to change both the north pole and the south pole into the north pole in FIG. 8B, and the north pole-side and south pole-side currents cancel each other. Therefore, in the comparative embodiment, even when pulse current is superimposed on q-axis current, currents cannot be induced in the rotor coils 88n and 88s. In contrast to this, in the present embodiment, pulse current is superimposed on the q-axis current as described above to make it possible to obtain the effect of increasing torque.

In addition, in the present embodiment, the width θ of each of the rotor coils 42n and 42s in the circumferential direction of the rotor 14 is regulated as described in the above mathematical expression (1), so it is possible to increase induced electromotive forces due to the space harmonics of the revolving magnetic fields, which are generated in the rotor coils 42n and 42s. That is, the amplitude (fluctuation width) of magnetic fluxes that link with the rotor coils 42n and 42s due to space harmonics is influenced by the width θ of each of the rotor coils 42n and 42s in the circumferential direction. Here, FIG. 3B shows the result of calculating the amplitude (fluctuation width) of magnetic fluxes that link with the rotor coils 42n and 42s while varying the width θ of each of the rotor coils 42n and 42s in the circumferential direction. FIG. 3B shows the coil width θ in electric angle. As shown in FIG. 3B, as the coil width θ reduces from 180°, the fluctuation width of magnetic fluxes that link with the rotor coils 42n and 42s increases, so the coil width θ is made smaller than 180°, that is, the rotor coils 42n and 42s are formed by short pitch winding, to thereby make it possible to increase the amplitude of linked magnetic fluxes due to space harmonics as compared with full pitch winding.

Thus, in the rotary electric machine 10 (FIG. 2), the width of each of the teeth 19 in the circumferential direction is made smaller than the width corresponding to 180° in electric angle, and the rotor coils 42n and 42s are wound around the corresponding teeth 19 by short pitch winding to thereby make it possible to efficiently increase induced electromotive forces due to space harmonics, which are generated in the rotor coils 42n and 42s. As a result, torque that acts on the rotor 14 may be efficiently increased.

Furthermore, as shown in FIG. 3B, when the coil width θ is 90°, the amplitude of linked magnetic fluxes due to space harmonics is maximal. Thus, in order to further increase the amplitude of magnetic fluxes that link with the rotor coils 42n and 42s due to space harmonics, the width θ of each of the rotor coils 42n and 42s in the circumferential direction is desirably equal to (or substantially equal to) the width corresponding to 90° in electric angle of the rotor 14. Therefore, where the number of pole pairs of the rotor 14 is p and the distance from the rotation central axis of the rotor 14 to each of the rotor coils 42n and 42s is r, the width θ of each of the rotor coils 42n and 42s in the circumferential direction desirably satisfies (or substantially satisfies) the following mathematical expression (2).

θ=π×r/(2×p) (2)

By so doing, induced electromotive forces due to space harmonics, which are generated in the rotor coils 42n and 42s, may be maximized, and magnetic fluxes that are generated in the respective teeth 19 because of induced currents may be most efficiently increased. As a result, it is possible to further efficiently increase torque that acts on the rotor 14. That is, when the width θ significantly exceeds the width corresponding to 90°, magnetomotive forces in the directions to cancel each other tend to link with the rotor coils 42n and 42s; however, the possibility of occurrence of those magnetomotive forces decreases as the width θ becomes smaller than the width corresponding to 90°. However, when the width θ significantly reduces with respect to the width corresponding to 90°, the magnitudes of magnetomotive forces that link with the rotor coils 42n and 42s significantly decrease. Therefore, the width θ is set to the width corresponding to about 90° to thereby make it possible to prevent such inconvenience. Therefore, the width θ of each of the rotor coils 42n and 42s in the circumferential direction is desirably substantially equal to the width corresponding to 90° in electric angle.

In this way, in the present embodiment, when the width θ of each of the rotor coils 42n and 42s in the circumferential direction of the rotor 14 is substantially equal to the width corresponding to 90° in electric angle, induced electromotive forces due to the space harmonics of the revolving magnetic fields, which are generated in the rotor coils 42n and 42s, may be increased, so it is possible to most efficiently increase the magnetic fluxes of the teeth 19 that are magnetic pole portions. The magnetic fluxes of the teeth 19 are generated by induced currents flowing through the rotor coils 42n and 42s. As a result, it is possible to further efficiently increase torque that acts on the rotor 14. Note that, in the present embodiment, the rotor 14 is configured such that any adjacent rotor coils 42n and 42s in the circumferential direction are electrically isolated from each other, the rotor coils 42n arranged alternately in the circumferential direction are electrically connected in series with one another and the rotor coils 42s arranged alternately in the circumferential direction are electrically connected in series with one another. However, in the present embodiment, it is also applicable that, as in the case of the configuration shown in FIG. 21 to FIG. 23, the rotary electric machine includes the rotor 14, in which any one of the diodes 21n and 21s is connected to each of the rotor coils 42n and 42s that are wound around the corresponding teeth 19 and the rotor coils 42n and 42s are electrically isolated from each other, and the controller 38 has the decreasing pulse superimposing unit 72 (FIG. 4).

Note that, in the present embodiment, the controller 38 has the decreasing pulse superimposing unit 72 that superimposes decreasing pulse current on q-axis current and does not superimpose pulse current on d-axis current. Instead, in addition to the decreasing pulse superimposing unit 72 that superimposes decreasing pulse current on q-axis current command Iq*, the controller 38 may have an increasing pulse superimposing unit that superimposes increasing pulse current, which is pulse current that steeply increases and then steeply decreases in a pulse-shaped manner, on d-axis current command Id*. In this case, it is possible to increase the amount of fluctuations in magnetic fluxes that pass through d-axis magnetic paths generated by d-axis current while causing the three-phase stator currents to fall within the current limit range, so it is possible to further effectively increase the torque of the rotary electric machine by further increasing induced currents in the rotor.

In addition, in the present embodiment, the decreasing pulse superimposing unit 72 may be configured to superimpose decreasing pulse current on the q-axis current command Iq* only within a predetermined range defined by one or both of the torque and rotation speed of the rotary electric machine. For example, the decreasing pulse superimposing unit 72 may be configured to superimpose decreasing pulse current on the q-axis current command Iq* only when the rotation speed of the rotary electric machine is lower than or equal to a predetermined rotation speed and the torque of the rotary electric machine is larger than or equal to a predetermined torque.

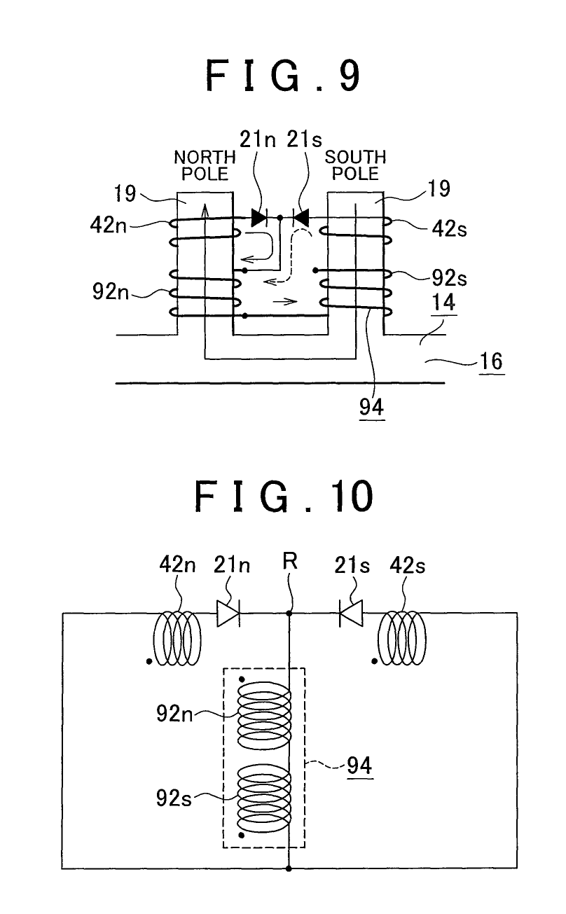

Next, FIG. 9 is a view that shows another embodiment of the invention and that corresponds to FIG. 3A. In addition, FIG. 10 is a view that shows an equivalent circuit of rotor coils and rotor auxiliary coils in the embodiment of FIG. 9. In the rotary electric machine according to the embodiment shown in FIG. 9, different from the embodiment shown in FIG. 1 to FIG. 6, the teeth 19 of the rotor 14 are provided with not only the rotor coils 42n and 42s wound around the distal end sides but also auxiliary rotor coils 92n and 92s wound around the proximal end sides. That is, in the present embodiment, as in the case of the embodiment shown in FIG. 1 to FIG. 6, the rotor core 16 includes the teeth 19. The teeth 19 are arranged at intervals in the circumferential direction of the rotor 14. The teeth 19 are a plurality of magnetic pole portions and salient portions that protrude toward the stator 12 (see FIG. 2). In addition, the teeth 19 are magnetized as currents rectified by the diodes 21n and 21s flow through the rotor coils 42n and 42s and the auxiliary rotor coils 92n and 92s to thereby function as magnets having fixed magnetic poles. In addition, the auxiliary rotor coils 92n and 92s are wound around the proximal end sides of the corresponding teeth 19, and are respectively wound around any adjacent teeth 19 in the circumferential direction of the rotor 14. Any two of the auxiliary rotor coils 92n and 92s are connected in series with each other to constitute an auxiliary coil set 94.

In addition, one ends of any adjacent two of the rotor coils 42n and 42s, wound around any adjacent two of the teeth 19 in the circumferential direction of the rotor 14, are connected to each other at a connection point R (FIG. 10) via the respectively corresponding diodes 21n and 21s such that the respectively corresponding diodes 21n and 21s face each other in opposite directions. In addition, the other ends of the any adjacent two of the rotor coils 42n and 42s in the circumferential direction of the rotor 14 each are connected to one end of the auxiliary coil set 94, and the connection point R is connected to the other end of the auxiliary coil set 94.

With such a configuration, rectified currents respectively flow through the rotor coils 42n and 42s and the auxiliary rotor coils 92n and 92s to magnetize the teeth 19 and to cause the teeth 19 to function as magnetic pole portions. That is, by passing alternating currents through the stator coils 28u, 28v and 28w, revolving magnetic fields that include space harmonics component act from the stator 12 (FIG. 2) on the rotor 14. Owing to fluctuations in magnetic fluxes of space harmonic components, fluctuations in leakage magnetic fluxes that leak into the space between the teeth 19 of the rotor 14 occur, and, by so doing, induced electromotive forces are generated. In addition, it is possible to mainly impart the function of generating induced currents to the rotor coils 42n and 42s at the distal end sides of the teeth 19 and to mainly impart the function of magnetizing the teeth 19 to the auxiliary rotor coils 92n and 92s. In addition, the total of currents flowing through the rotor coils 42n and 42s wound around any adjacent teeth 19 becomes current flowing through the auxiliary rotor coils 92n and 92s. In addition, any adjacent auxiliary rotor coils 92n and 92s are connected in series with each other, so the same advantageous effect as that when the number of turns of both adjacent auxiliary rotor coils 92n and 92s is increased may be obtained, and it is possible to reduce currents flowing through the rotor coils 42n and 42s and the auxiliary rotor coils 92n and 92s while magnetic fluxes passing through the teeth 19 are unchanged. The other configuration and operation are similar to those of the embodiment shown in FIG. 1 to FIG. 6.

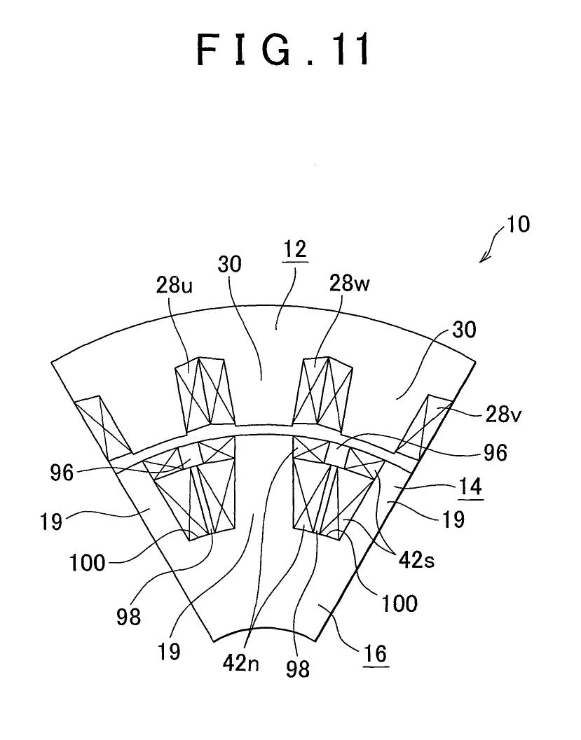

Next, FIG. 11 is a schematic cross-sectional view that partially shows a portion at which a stator faces a rotor in another embodiment of the invention. A rotary electric machine 10 according to the present embodiment differs from the embodiment shown in FIG. 1 to FIG. 6 or the embodiment shown in FIG. 9 and FIG. 10 in that an auxiliary pole 96 formed of a magnetic material is provided between any adjacent teeth 19 in the circumferential direction of the rotor 14. In addition, each auxiliary pole 96 is coupled to the distal end portion of a pillar portion 98 made of a non-magnetic material. The proximal portion of each pillar portion 98 is coupled to the center in the circumferential direction at the bottom of a slot 100 between any adjacent teeth in the circumferential direction on the outer peripheral surface of the rotor core 16. Note that, on the condition that each pillar portion 98 is formed of a magnetic material and the strength of the pillar portion 98 may be ensured, the cross-sectional area of the pillar portion 98 in the circumferential direction of the rotor 14 may be sufficiently reduced.

With the above configuration, magnetic paths through which space harmonic components pass may be easily formed at portion including the auxiliary poles 96, so a large amount of space harmonics included in the revolving magnetic fields generated by the stator 12 are caused to pass through the auxiliary poles 96 to thereby make it possible to increase fluctuations in magnetic fluxes of space harmonics. Therefore, induced currents that occur in the rotor coils 42n and 42s are further increased to thereby make it possible to further increase the torque of the rotary electric machine 10. The other configuration and operation are similar to those of the embodiment shown in FIG. 1 to FIG. 6.

Next, other configuration examples of a rotary electric machine that constitutes the rotary electric machine driving system according to the above described embodiments will be described. As described below, the aspect of the invention may be applied to various configuration examples of the rotary electric machine.

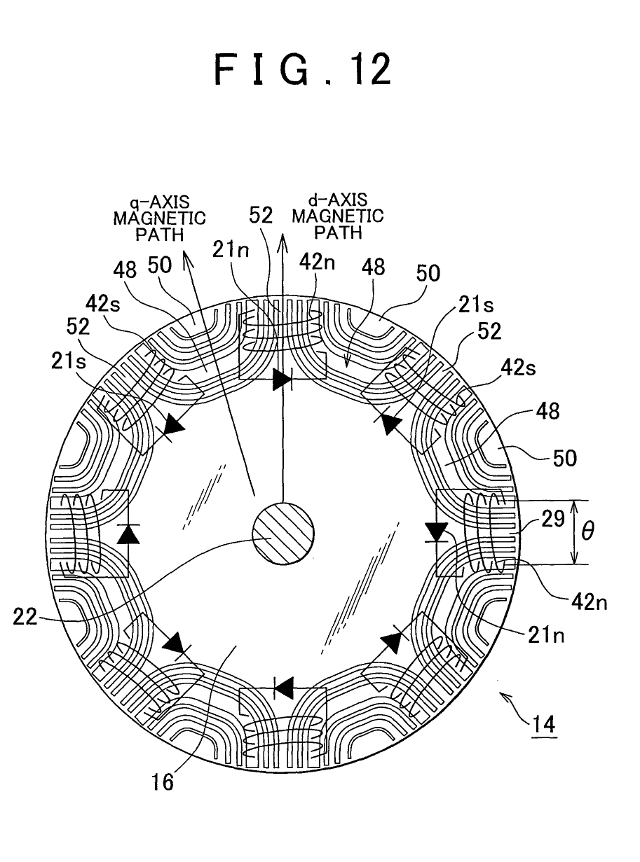

For example, in the above described embodiments, the rotor coils 42n and 42s are wound around the corresponding teeth that are salient poles protruding in the radial direction of the rotor 14; instead, it is also applicable that, as shown in FIG. 12, slits (airspaces) 48 that are rotor slots are formed in the rotor core 16 to thereby vary the magnetic resistance of the rotor 14 in accordance with the rotation direction. As shown in FIG. 12, in the rotor core 16, where each magnetic path of the circumferential center of a portion that is formed so as to arrange the plurality of slits 48 in the radial direction is a q-axis magnetic path portion 50 and each magnetic path in the direction along the magnetic pole portion at which the rotor coil is arranged is a d-axis magnetic path portion 52, the slits 48 are formed such that the q-axis magnetic path portion 50 and the d-axis magnetic path portion 52 facing the stator 12 (teeth 30) are arranged alternately in the circumferential direction, and each q-axis magnetic path portion 50 is located between any adjacent d-axis magnetic path portions 52 in the circumferential direction.

Each of the rotor coils 42n and 42s is wound through the slits 48 around a corresponding one of the d-axis magnetic path portions 52 having a low magnetic resistance. In this case, the slits 48 are formed in the rotor core 16 at intervals in the circumferential direction around the rotation axis of the rotor 14, and the rotor coils 42n and 42s are wound at multiple portions in the circumferential direction on the outer peripheral portion of the rotor core 16 so as to be partially arranged in the slits 48. In the configuration example shown in FIG. 12, the revolving magnetic fields that include space harmonic components and that are formed in the stator 12 link with the rotor coils 42n and 42s to cause direct currents rectified by the diodes 21n and 21s to flow through the rotor coils 42n and 42s to thereby magnetize the d-axis magnetic path portions 52. As a result, the d-axis magnetic path portions 52 function as magnets (magnetic pole portions) having fixed magnetic poles. At this time, the width of each d-axis magnetic path portion 52 (the width θ of each of the rotor coils 42n and 42s) in the circumferential direction is set so as to be shorter than the width corresponding to 180° in electric angle of the rotor 14, and the rotor coils 42n and 42s are wound around the corresponding d-axis magnetic path portions 52 by short pitch winding. By so doing, it is possible to efficiently increase induced electromotive forces due to space harmonics, which are generated in the rotor coils 42n and 42s. Furthermore, in order to maximize induced electromotive forces due to space harmonics, which are generated in the rotor coils 42n and 42s, the width θ of each of the rotor coils 42n and 42s in the circumferential direction is desirably equal (or substantially equal to) the width corresponding to 90° in electric angle of the rotor 14. The other configuration and operation are similar to those of the above described embodiments.

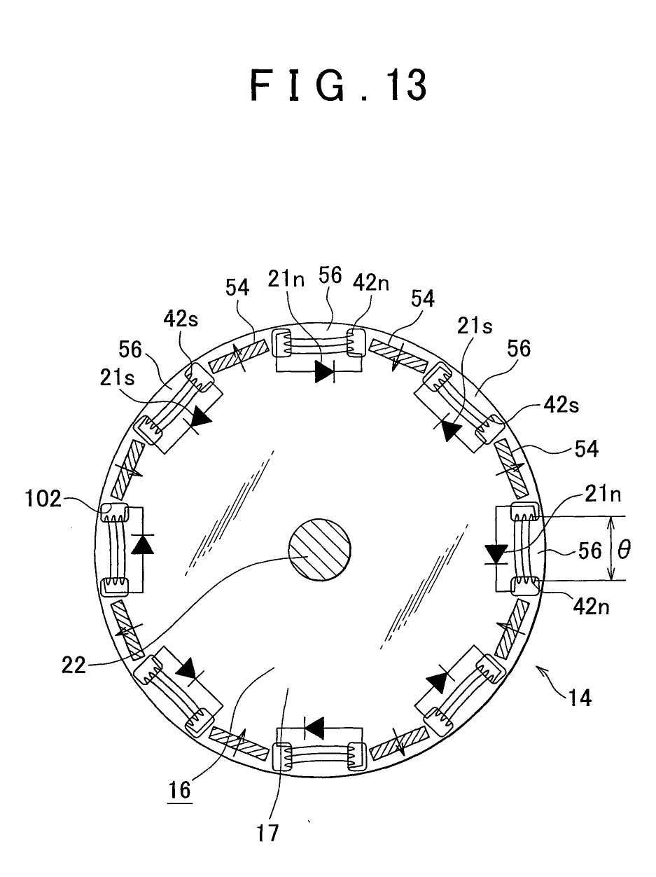

In addition, in the above described embodiments, for example as shown in FIG. 13, it is also applicable that the rotor core 16 includes a rotor core body 17 made of a magnetic material and a plurality of permanent magnets 54 and the permanent magnets 54 are arranged on the rotor core 16. In the configuration example shown in FIG. 13, a plurality of magnetic pole portions 56 that function as magnets having fixed magnetic poles are arranged so as to face the stator 12 (see FIG. 2) at intervals in the circumferential direction, and the rotor coils 42n and 42s are wound around the corresponding magnetic pole portions 56. In this case, slits 102 that are rotor slots are formed at multiple portions of the rotor core 16 in the circumferential direction, and the rotor coils 42n and 42s are wound at multiple portions in the circumferential direction on the outer peripheral portion of the rotor core 16 so as to be partially arranged in the slits 102. Each of the permanent magnets 54 is arranged so as to face the stator 12 (teeth 30) between any adjacent magnetic pole portions 56 in the circumferential direction. The permanent magnets 54 here may be embedded in the rotor core 16 or may be exposed to the surface (outer peripheral surface) of the rotor core 16. In addition, the permanent magnets 54 may be arranged inside the rotor core 16 in a V shape. In the configuration example shown in FIG. 13, the revolving magnetic fields that include space harmonic components, which are formed in the stator 12, link with the rotor coils 42n and 42s to cause direct currents rectified by the diodes 21n and 21s to flow through the rotor coils 42n and 42s to thereby magnetize the magnetic pole portions 56. As a result, the magnetic pole portions 56 function as magnets having fixed magnetic poles. At this time, the width of each of the magnetic pole portions 56 (the width θ of each of the rotor coils 42n and 42s) in the circumferential direction is set so as to be shorter than the width corresponding to 180° in electric angle of the rotor 14, and the rotor coils 42n and 42s are wound around the corresponding magnetic pole portions 56 by short pitch winding to thereby make it possible to efficiently increase induced electromotive forces due to space harmonics, which are generated in the rotor coils 42n and 42s. Furthermore, in order to maximize induced electromotive forces due to space harmonics, which are generated in the rotor coils 42n and 42s, the width θ of each of the rotor coils 42n and 42s in the circumferential direction is desirably equal (or substantially equal to) the width corresponding to 90° in electric angle of the rotor 14. The other configuration and operation are similar to those of the above described embodiments.

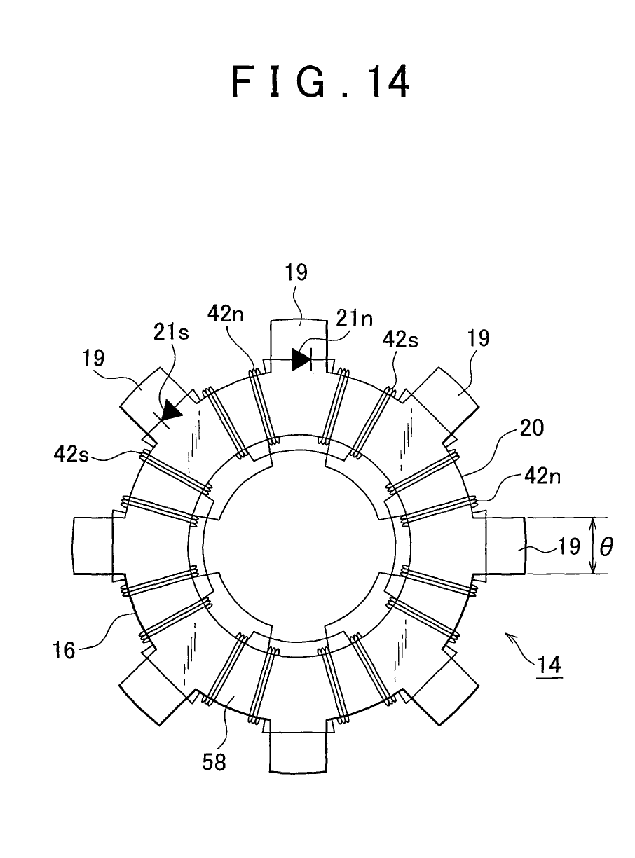

In addition, in the above described embodiments, for example, as shown in FIG. 14, the rotor coils 42n and 42s may be wound by toroidal winding. In the configuration example shown in FIG. 14, the rotor core 16 includes an annular core portion 58, and each of the teeth 19 protrudes from the annular core portion 58 toward the outer side in the radial direction (toward the stator 12). The rotor coils 42n and 42s are wound at positions of the annular core portion 58 near the teeth 19 by toroidal winding. In addition, the rotor coils 42n and 42s are wound at multiple portions of the rotor core 16 in the circumferential direction so as to be partially arranged in the slots 20. In the configuration example shown in FIG. 14 as well, the revolving magnetic fields that include space harmonic components, which are formed in the stator 12, link with the rotor coils 42n and 42s to cause direct currents rectified by the diodes 21n and 21s to flow through the rotor coils 42n and 42s to thereby magnetize the teeth 19. As a result, the teeth 19 located near the rotor coils 42n function as north poles, and the teeth 19 located near the rotor coils 42s function as south poles. At this time, the width θ of each of the teeth 19 in the circumferential direction is set so as to be shorter than the width corresponding to 180° in electric angle of the rotor 14 to thereby make it possible to efficiently increase induced electromotive forces due to space harmonics, which are generated in the rotor coils 42n and 42s. Furthermore, in order to maximize induced electromotive forces due to space harmonics, which are generated in the rotor coils 42n and 42s, the width θ of each of the teeth 19 in the circumferential direction is desirably equal (or substantially equal to) the width corresponding to 90° in electric angle of the rotor 14. Note that FIG. 14 shows an example in which any adjacent rotor coils 42n and 42s in the circumferential direction are electrically isolated from each other, the rotor coils 42n arranged alternately in the circumferential direction are electrically connected in series with one another and the rotor coils 42s arranged alternately in the circumferential direction are electrically connected in series with one another as in the case of the configuration example shown in FIG. 2. However, in the example in which the rotor coils 42n and 42s are wound by toroidal winding as well, as in the case of the configuration example shown in FIG. 21 to FIG. 23, the rotor coils 42n and 42s wound around the corresponding teeth 19 each may be electrically isolated from one another. The other configuration and operation are similar to those of the above described embodiments.

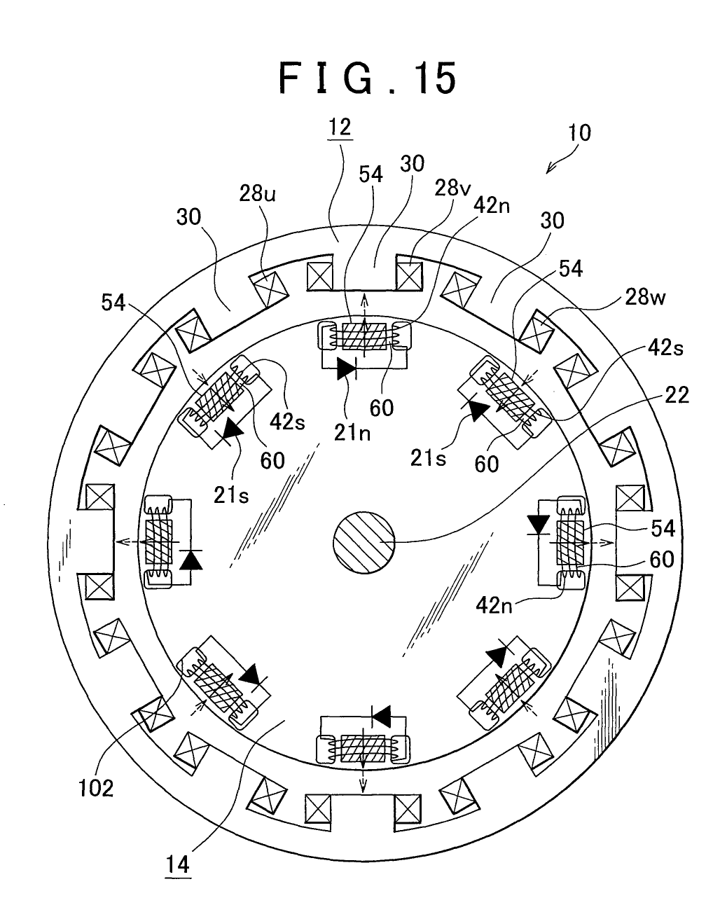

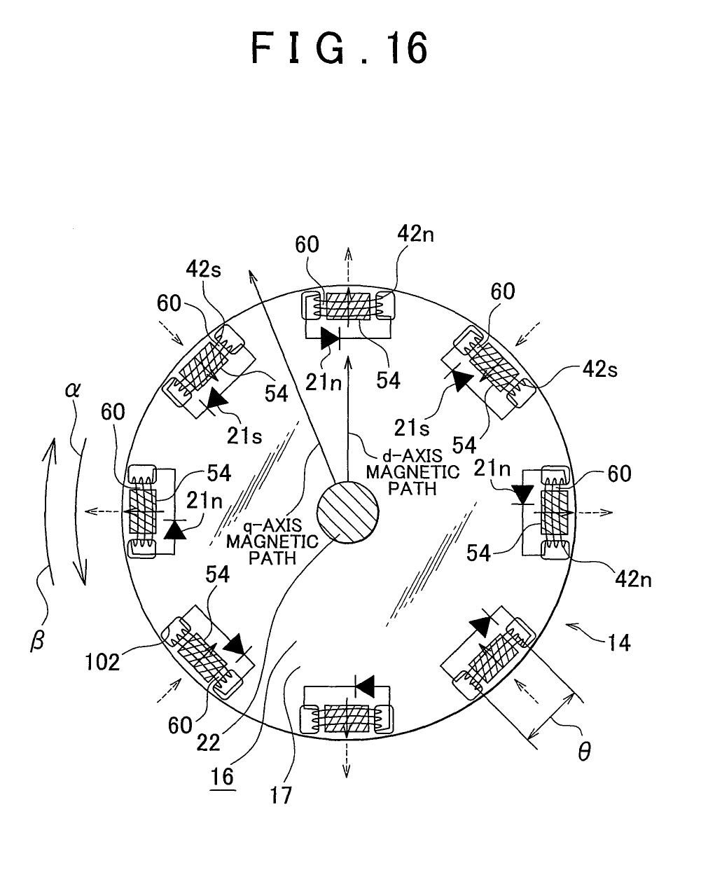

In addition, as described in the following configuration example, in the above described embodiments, it is applicable that the rotor coils of the rotary electric machine are arranged at the same positions as those of the magnets of the rotor, at the same positions as those of the slots, each of which is formed between any adjacent teeth, or at the same positions as those of the portions having magnetic salient pole characteristics due to the plurality of slits. FIG. 15 is a schematic view of a rotary electric machine when viewed in the direction parallel to the rotation axis. FIG. 16 is a schematic view that shows the schematic configuration of the rotor of FIG. 15 when viewed in the direction parallel to the rotation axis.

The rotary electric machine 10 according to the present configuration example includes a stator 12 and a rotor 14. The stator 12 is fixed to a casing (not shown). The rotor 14 is arranged on the inner side of the stator 12 in the radial direction so as to face the stator 12 with a predetermined gap, and is rotatable with respect to the stator 12. Note that the configuration and operation of the stator 12 are similar to those of the embodiment shown in FIG. 1 to FIG. 6.

As shown in FIG. 16, the rotor 14 includes a rotor core 16 and rotor coils 42n and 42s. The rotor coils 42n and 42s are arranged and wound at multiple portions of the rotor core 16 in the circumferential direction. The rotor core 16 includes a rotor core body 17 made of a magnetic material and permanent magnets 54 arranged at multiple portions of the rotor 14 in the circumferential direction. The rotor 14 is fixed to the rotary shaft 22. Magnetic pole portions 60, such as pillar portions extending in the radial direction, are formed at multiple portions of the rotor core 16 in the circumferential direction, and the rotor coils 42n and 42s are wound around the corresponding magnetic pole portions 60. That is, slits 102 that are rotor slots are formed at multiple portions of the rotor core 16 in the circumferential direction, and the rotor coils 42n and 42s are wound at multiple portions of the outer peripheral portion of the rotor core 16 in the circumferential direction so as to be partially arranged in the slits 102.

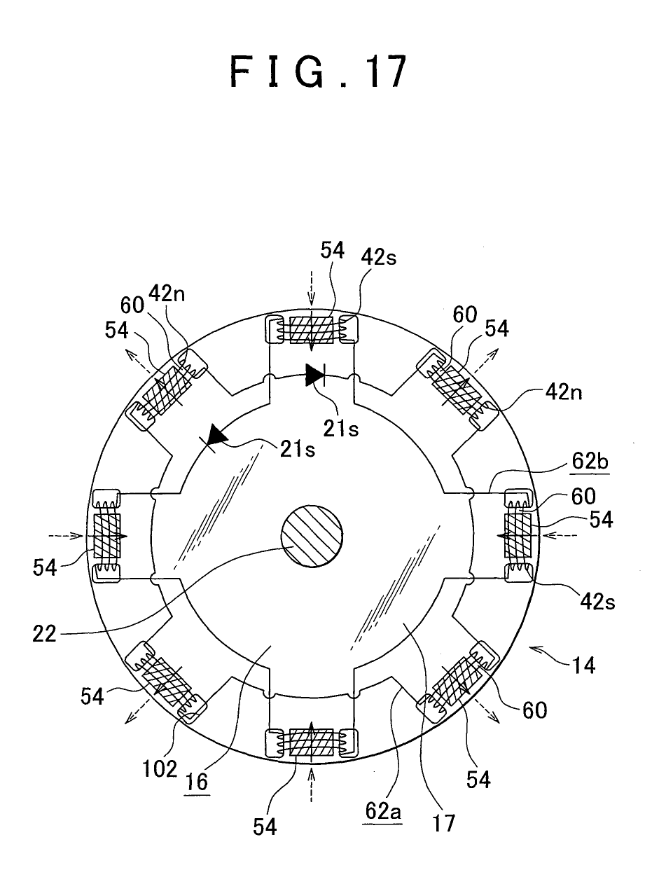

The permanent magnets 54 are arranged, that is, embedded, inside the magnetic pole portions 60 at multiple portions of the rotor 14 in the circumferential direction, which correspond to the rotor coils 42n and 42s in the circumferential direction of the rotor 14. Conversely, the rotor coils 42n and 42s are wound around the corresponding permanent magnets 54. The permanent magnets 54 are magnetized in the radial direction of the rotor 14, and the magnetized directions are varied between any adjacent permanent magnets 54 in the circumferential direction of the rotor 14. In FIG. 15 and FIG. 16 (the same applies to FIG. 17 described later), the solid arrows on the permanent magnets 54 indicate the magnetized directions of the permanent magnets 54. Note that the magnetic pole portions 60 may be formed of salient poles, or the like, that are arranged so as to extend in the radial direction at multiple portions of the rotor 14 in the circumferential direction.

The rotor 14 has different magnetic salient pole characteristics in the circumferential direction. Where the magnetic path of the circumferential center between any adjacent magnetic pole portions 60 in the circumferential direction, which is located so as to deviate from the permanent magnets 54 in the circumferential direction and also deviate from the magnetic pole portions 60 in the rotor 14 is termed a q-axis magnetic path and the magnetic path that coincides in the circumferential direction with the winding central axis of each of the rotor coils 42n and 42s is termed a d-axis magnetic path, the permanent magnets 54 are respectively arranged in the d-axis magnetic paths located at multiple portions of the rotor 14 in the circumferential direction.

In addition, the rotor coils 42n and 42s wound around the corresponding magnetic pole portions 60 are not electrically connected to one another but are isolated (insulated) from one another. Then, any one of diodes 21n and 21s that are rectifier elements is connected in parallel with each of the electrically isolated rotor coils 42n and 42s. In addition, the direction in which current flows through each of the diodes 21n connected to the alternately arranged rotor coils 42n in the circumferential direction of the rotor 14 and the direction in which current flows through each of diodes 21s connected to the remaining rotor coils 42s are inverted to set the forward directions of the diodes 21n and 21s in opposite directions. Therefore, each of the rotor coils 42n and 42s is short-circuited via the diode 21n or 21s. Thus, currents that flow through the rotor coils 42n and 42s are rectified in one direction. In the case of the present configuration example as well, the diodes 21n and 21s rectify currents that flow through the rotor coils 42n and 42s because of generated induced electromotive forces to thereby vary the phases of currents flowing through any adjacent rotor coils 42n and 42s in the circumferential direction of the rotor 14 alternately between the A phase and the B phase.

When direct currents according to the rectification directions of the diodes 21n and 21s flow through the rotor coils 42n and 42s, the magnetic pole portions 60 around which the rotor coils 42n and 42s are wound are magnetized to cause the magnetic pole portions 60 to function as magnets having fixed magnetic poles. The directions of the broken arrows shown on the outer sides of the rotor coils 42n and 42s in the radial direction of the rotor 14 in FIG. 15 and FIG. 16 indicate the magnetized directions of the magnetic pole portions 60.

In addition, as shown in FIG. 16, the directions of direct currents are mutually opposite between any adjacent rotor coils 42n and 42s in the circumferential direction of the rotor 14. Then, the magnetized directions are mutually opposite between any adjacent magnetic pole portions 60 in the circumferential direction of the rotor 14. That is, in the present configuration example, the magnetic characteristics of the magnetic pole portions 60 are alternately varied in the circumferential direction of the rotor 14. For example, in FIG. 15 and FIG. 16, the north poles are arranged on the radially outer sides of portions that coincide in the circumferential direction of the rotor 14 with the rotor coils 42n, which are the alternately arranged magnetic pole portions 60 in the circumferential direction of the rotor 14, and south poles are arranged on the radially outer sides of portions that coincide in the circumferential direction of the rotor 14 with the rotor coils 42s, which are the magnetic pole portion 60 adjacent to the north-pole magnetic pole portions 60 in the circumferential direction. Then, any adjacent two of the magnetic pole portions 60 (north pole and south pole) in the circumferential direction of the rotor 14 constitute one pole pair. In addition, the magnetized directions of the permanent magnets 54 are brought into coincidence with the magnetized directions of the magnetic pole portions 60 that coincide in the circumferential direction of the rotor 14 with the permanent magnets 54.

In addition, in the example shown in FIG. 15 and FIG. 16, the eight magnetic pole portions 60 are formed, and the number of pole pairs of the rotor 14 is four. In addition, the number of pole pairs of the stator 12 (FIG. 15) and the number of pole pairs of the rotor 14 both are four, and the number of pole pairs of the stator 12 is equal to the number of pole pairs of the rotor 14. However, the number of pole pairs of the stator 12 and the number of pole pairs of the rotor 14 each may be other than four.

In addition, in the present configuration example, the width of each of the magnetic pole portions 60 in the circumferential direction of the rotor 14 is set so as to be shorter than the width corresponding to 180° in electric angle of the rotor 14. Then, the width θ (FIG. 16) of each of the rotor coils 42n and 42s in the circumferential direction is set so as to be shorter than the width corresponding to 180° in electric angle of the rotor 14, and the rotor coils 42n and 42s are wound around the corresponding magnetic pole portions 60 by short pitch winding. In addition, desirably, the width θ of each of the rotor coils 42n and 42s in the circumferential direction of the rotor 14 is equal to (or substantially equal to) the width corresponding to 90° in electric angle.

In the thus configured rotary electric machine 10, three-phase alternating currents are passed through the three-phase stator coils 28u, 28v and 28w to cause the revolving magnetic fields having frequencies that include harmonic components, which are generated by the teeth 30 (FIG. 15), to be applied to the rotor 14. Then, in response to this, reluctance torque Tre, permanent magnet torque Tmg generated by the permanent magnets and rotor coil torque Tcoil generated by the rotor coils act on the rotor 14 to cause the rotor 14 to be driven for rotation in synchronization with the revolving magnetic fields (fundamental components) generated by the stator 12. Here, the reluctance torque Tre is torque generated as a result of the respective magnetic pole portions 60 being attracted by the revolving magnetic fields generated by the stator 12. In addition, the permanent magnet torque Tmg is torque generated because of attraction and repulsion actions, which are interactions between the magnetic fields generated by the permanent magnets 54 and the revolving magnetic fields generated by the stator 12. In addition, the rotor coil torque Tcoil is torque caused by currents induced by the rotor coils 42n and 42s as a result of the space harmonic components of magnetomotive force generated by the stator 12 being applied to the rotor coils 42n and 42s. This torque is generated by attraction and repulsion actions, which are electromagnetic interactions between the magnetic fields generated by the magnetic pole portions 60 and the revolving magnetic fields generated by the stator 12.

With the above rotary electric machine 10 according to the present configuration example, it is possible to effectively increase the torque of the rotary electric machine 10. In addition, fluctuations in magnetic fluxes in the permanent magnets 54 are suppressed by induced currents flowing through the rotor coils 42n and 42s, so losses of eddy currents inside the respective permanent magnets 54 are suppressed to make it possible to reduce heat generation of magnets.

In addition, FIG. 17 is a schematic view that corresponds to FIG. 16 in another configuration example. In the present configuration example, the rotor coils 42n, which are part of the plurality of rotor coils 42n and 42s, arranged alternately in the circumferential direction of the rotor 14, are electrically connected in series with one another, and the remaining rotor coils 42s arranged alternately in the circumferential direction are electrically connected in series with one another. That is, the rotor coils 42n or 42s that are wound around the magnetic pole portions 60 that function as magnets and that are magnetized in the same directions are electrically connected in series with one another. In addition, the rotor coils 42n and 42s wound around any adjacent magnetic pole portions 60 in the circumferential direction of the rotor 14 are electrically isolated from each other. Then, a circuit that includes the rotor coils 42n that are electrically connected to one another and a circuit that includes the rotor coils 42s that are electrically connected to one another constitute a pair of rotor coil circuits 62a and 62b that are electrically isolated from each other. That is, the rotor coils 42n or 42s wound around the magnetic pole portions 60 having mutually the same magnetic characteristics are electrically connected to one another.

In addition, diodes 21n and 21s that are rectifier elements and that have mutually different polarities are respectively connected to the pair of rotor coil circuits 62a and 62b in series with the alternately arranged rotor coils 42n and 42s, and the directions of currents flowing through the rotor coil circuits 62a and 62b are rectified in one direction. In addition, current flowing through one of the pair of rotor coil circuits 62a and 62b and current flowing through the other one of the rotor coil circuits 62a and 62b are opposite to each other. The other configuration and operation are similar to those of the configuration example shown in FIG. 15 and FIG. 16.

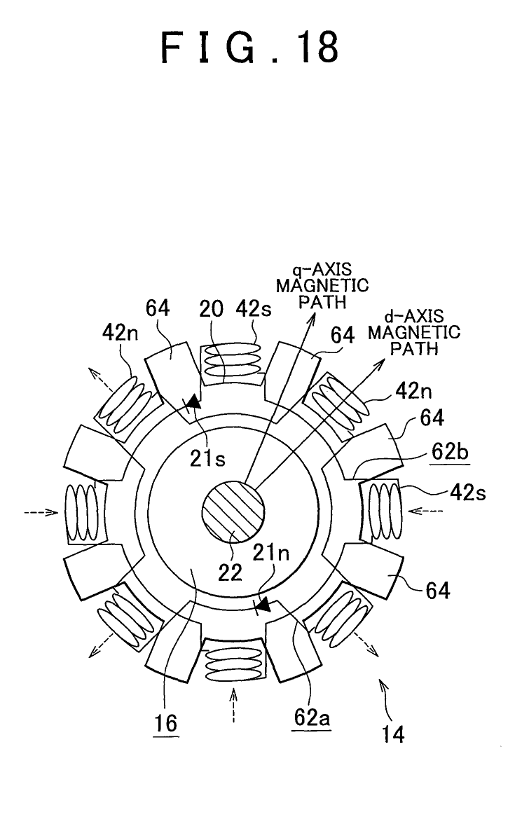

FIG. 18 is a schematic view that corresponds to FIG. 16 in another configuration example. The rotor 14 that constitutes the rotary electric machine according to the present configuration example differs from the rotor 14 in the configuration example shown in FIG. 17 in that the permanent magnets 54 (see FIG. 17) provided for the rotor 14 are omitted. In addition, the rotor core 16 includes teeth 64 that protrudes in the radial direction at multiple portions of the outer peripheral surface in the circumferential direction, and arranges any one of the rotor coils 42n and 42s between any adjacent teeth 64 in the circumferential direction of the rotor 14. That is, the rotor coils 42n and 42s are arranged in a hollow state where the inside is hollow. In addition, a portion between any adjacent rotor coils 42n and 42s in the circumferential direction of the rotor 14 protrudes toward the stator 12 (see FIG. 15), and the rotor core 16 has magnetic salient pole characteristics. In this case, the rotor coils 42n and 42s are wound at multiple portions of the outer peripheral portion of the rotor core 16 in the circumferential direction so as to be partially or wholly arranged in the corresponding slots 20.

In the thus configured rotor 14, magnetic paths that coincide with the teeth 64 in the circumferential direction of the rotor 14 become q-axis magnetic paths, and positions that coincide with the rotor coils 42n and 42s in the circumferential direction of the rotor 14 become d-axis magnetic paths.

With the above present configuration example, different from the configuration example shown in FIG. 15 and FIG. 16, no permanent magnets 54 (see FIG. 17) are arranged in the rotor 14; however, the torque of the rotary electric machine may be increased irrespective of the rotation direction of the rotor 14. That is, the current phase-torque characteristic is the same irrespective of the rotation direction of the rotor 14, and the maximum value of the torque increases, so the torque may be effectively increased. For example, when power running torque is increased, it is possible to increase power running torque both during forward rotation and reverse rotation of the rotor 14. In addition, when regenerative torque is increased, it is possible to increase regenerative torque both during forward rotation and reverse rotation of the rotor 14. Thus, it is possible to achieve the rotary electric machine that is able to obtain high torque both in forward rotation and reverse rotation of the rotor 14. The other configuration and operation are similar to those of the configuration example shown in FIG. 15 and FIG. 16 or the configuration example shown in FIG. 17.

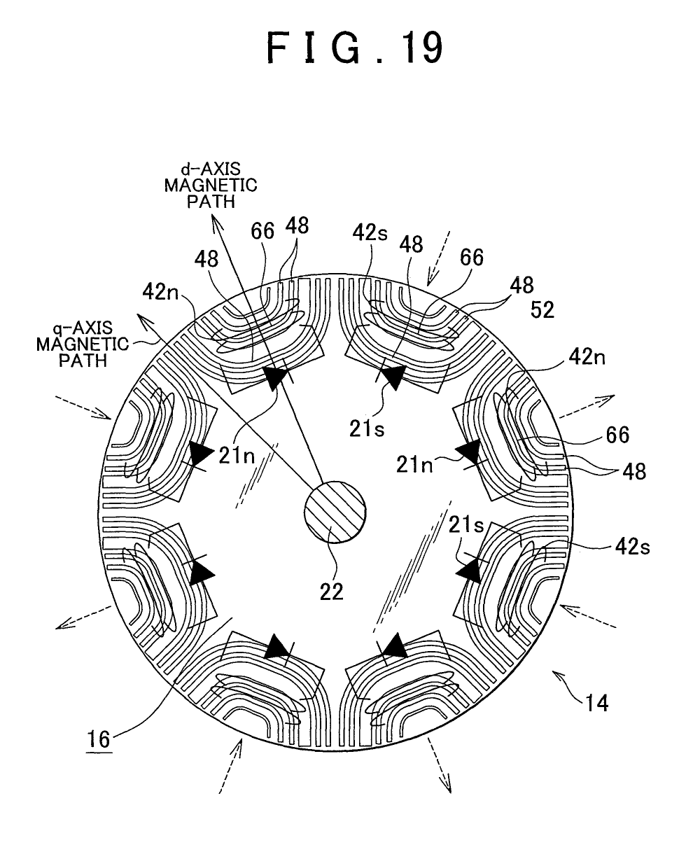

FIG. 19 is a schematic view that corresponds to FIG. 16 in another configuration example. The rotor 14 that constitutes a rotary electric machine according to the present configuration example is also configured such that no permanent magnets 54 (see FIG. 16, and the like) are provided for the rotor 14 as in the case of the configuration example shown in FIG. 18. In the present configuration example, slits 48 that are airspace portions and rotor slots are formed inside the rotor core 16 that constitutes the rotor 14 to thereby vary the magnetic resistance of the rotor 14 in the rotation direction. That is, the plurality of slits 48 that extend in the axial direction in a substantially U shape in cross section and that have an open shape toward the outer side in the radial direction are arranged at multiple portions of the rotor core 16 in the circumferential direction so as to be spaced apart in the radial direction of the rotor 14. Then, rotor coils 42n and 42s are arranged at multiple portions of the rotor core 16 in the circumferential direction so as to coincide with the circumferential centers of the plurality of slits 48 to form d-axis magnetic paths, and the magnetic path between any adjacent slits 48 in the circumferential direction is a q-axis magnetic path.

In addition, the rotor coils 42n and 42s are respectively short-circuited by diodes 21n and 21s. The diodes 21n and 21s have different polarities between any adjacent rotor coils 42n and 42s. The rotor coils 42n respectively short-circuited by the diodes 21n and the rotor coils 42s respectively short-circuited by the diodes 21s are alternately arranged in the circumferential direction of the rotor 14, and the magnetic characteristics of the plurality of magnetic pole portions 66, generated by currents flowing through the rotor coils 42n and 42s, are alternately varied in the circumferential direction of the rotor 14. In this case, the slits 48 are formed at intervals in the circumferential direction around the rotation axis of the rotor 14 in the rotor core 16, and the rotor coils 42n and 42s are wound at multiple portions in the circumferential direction on the outer peripheral portion of the rotor core 16 so as to be partially arranged in the slits 48.

In the case of the above present configuration example, revolving magnetic fields from the stator 12 (see FIG. 15) link with the rotor coils 42n and 42s to cause direct currents rectified by the diodes 21n and 21s to flow through the rotor coils 42n and 42s to thereby magnetize the magnetic pole portions 66 located at multiple portions in the circumferential direction, that is, the d-axis magnetic paths, and the magnetic pole portions 66 function as magnets having fixed magnetic poles. In addition, the width of each of the rotor coils 42n and 42s in the circumferential direction of the rotor 14 is set so as to be shorter than the width corresponding to 180° in electric angle of the rotor 14, and the rotor coils 42n and 42s are wound around the respective magnetic pole portions 60 by short pitch winding. In addition, desirably, the width of each of the rotor coils 42n and 42s in the circumferential direction is equal to (or substantially equal to) the width corresponding to 90° in electric angle of the rotor 14.

In the case of the above present configuration example as well, no permanent magnets are arranged on the rotor 14; however, the torque of the rotary electric machine may be increased irrespective of the rotation direction of the rotor 14. The other configuration and operation are similar to those of the configuration example shown in FIG. 15 and FIG. 16.

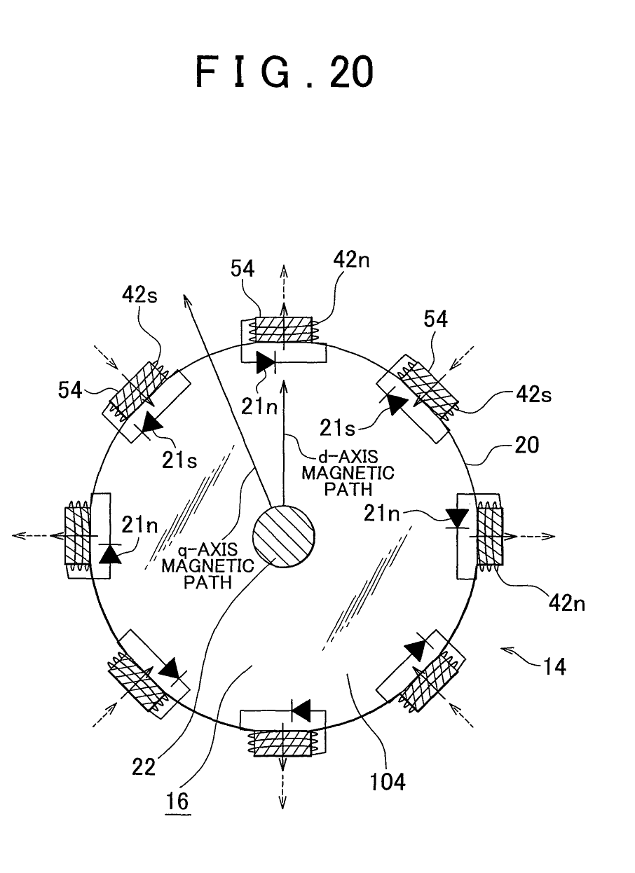

FIG. 20 is a schematic view that corresponds to FIG. 16 in another configuration example. The rotor 14 that constitutes a rotary electric machine according to the present configuration example differs from the rotor 14 that constitutes the configuration example shown in FIG. 15 and FIG. 16 in that the rotor core 16 is formed of a rotor core body 104 made of a magnetic material and a plurality of permanent magnets 54. In addition, the rotor core body 104 does not have a magnetic salient pole characteristic, and the permanent magnets 54 are fixed at multiple portions of the outer peripheral surface of the rotor core body 104 in the circumferential direction. In addition, the rotor core 16 is formed such that a slot 20 is formed between any adjacent permanent magnets 54 at intervals in the circumferential direction around the rotation axis of the rotor. In addition, rotor coils 42n and 42s are wound around the corresponding permanent magnets 54. In this case, the rotor coils 42n and 42s are wound at multiple portions of the outer peripheral portion of the rotor core 16 in the circumferential direction so as to be partially arranged in the slots 20. In the present configuration example, portions that coincide in the circumferential direction with the permanent magnets 54 at multiple portions of the rotor 14 in the circumferential direction are formed as magnetic pole portions. In addition, the rotor coils 42n and 42s are respectively short-circuited by diodes 21n and 21s. The diodes 21n and 21s have different polarities between any adjacent rotor coils 42n and 42s. The other configuration and operation are similar to those of the configuration example shown in FIG. 15 and FIG. 16.

In the above embodiments and configuration examples, the radial rotary electric machine in which the stator 12 and the rotor 14 are arranged so as to face each other in the radial direction perpendicular to the rotary shaft 22 is described. However, the rotary electric machine that constitutes the above described embodiments may be an axial rotary electric machine in which the stator 12 and the rotor 14 are arranged so as to face each other in the direction parallel to the rotary shaft 22 (direction along the rotation axis). In addition, the case where the rotor is arranged on the inner side of the stator in the radial direction so as to face the stator is described above; instead, the aspect of the invention may also be implemented by the configuration that the rotor is arranged on the outer side of the stator in the radial direction so as to face the stator.

As described above, a rotary electric machine driving system according to the present embodiment includes: a rotary electric machine having a stator and a rotor that are arranged so as to face each other; a driving unit that drives the rotary electric machine; and a control unit that controls the driving unit. The stator has a stator core having stator slots formed at multiple portions in a circumferential direction and multi-phase stator coils wound around the stator core via the stator slots by concentrated winding. The rotor has a rotor core, rotor coils wound at multiple portions of the rotor core in the circumferential direction and a rectifier unit that is connected to the rotor coils and that varies magnetic characteristics of the respective rotor coils alternately in the circumferential direction among the plurality of rotor coils. The rotor varies magnetic characteristics of magnetic pole portions at multiple portions in the circumferential direction alternately in the circumferential direction. The magnetic characteristics are generated by currents flowing through the respective rotor coils. The control unit has a decreasing pulse superimposing unit that superimposes decreasing pulse current for a pulse-shaped decrease on a q-axis current command for passing currents through the stator coils so as to generate field magnetic fluxes in directions advanced by 90 degrees in electric angle with respect to magnetic pole directions that are winding central axis directions of the respective rotor coils. Then, with this configuration, as described above, it is possible to achieve the rotary electric machine that is able to increase torque even in a low rotation speed range while preventing excessive currents from flowing through the stator coils.

The embodiments of the invention are described above; however, the aspect of the invention is not limited to the above embodiments. The aspect of the invention may be, of course, implemented in various forms without departing from the scope of the invention.

1. A rotary electric machine driving system comprising:
a rotary electric machine having a stator and a rotor that are arranged so as to face each other;
a driving unit that drives the rotary electric machine; and
a control unit that controls the driving unit, wherein
the stator has a stator core having a plurality of stator slots at intervals in a circumferential direction around a rotation axis of the rotor and multi-phase stator coils that are wound around the stator core via the stator slots by concentrated winding,
the rotor has a rotor core having a plurality of rotor slots at intervals in the circumferential direction around the rotation axis of the rotor, rotor coils that are wound at multiple portions of the rotor core in the circumferential direction so as to be at least partially arranged in the rotor slots and a rectifier unit that is connected to the rotor coils and that varies magnetic characteristics of the respective rotor coils alternately in the circumferential direction among the plurality of rotor coils, the rotor varying magnetic characteristics of magnetic pole portions at multiple portions in the circumferential direction alternately in the circumferential direction, the magnetic characteristics being generated by currents flowing through the respective rotor coils, and
the control unit has a decreasing pulse superimposing unit that superimposes decreasing pulse current for a pulse-shaped decrease on a q-axis current command for passing currents through the stator coils so as to generate field magnetic fluxes in directions advanced by 90 degrees in electric angle with respect to magnetic pole directions that are winding central axis directions of the respective rotor coils.

2. The rotary electric machine driving system according to claim 1, wherein
each of the rotor coils is connected to any one of rectifier elements that serve as the rectifier unit and of which forward directions are opposite between any adjacent two of the rotor coils in the circumferential direction of the rotor, and the rectifier elements rectify currents that are generated by induced electromotive forces to flow through the rotor coils to thereby vary phases of currents flowing through any adjacent two of the rotor coils in the circumferential direction alternately between an A phase and a B phase.

3. The rotary electric machine driving system according to claim 2, wherein
the rectifier elements are a first rectifier element and a second rectifier element that are respectively connected to the corresponding rotor coils, and
the first rectifier element and the second rectifier element independently rectify currents generated due to the generated induced electromotive forces so that the rectified currents flow through the corresponding rotor coils, and vary the magnetic characteristics of the magnetic pole portions at multiple portions in the circumferential direction alternately in the circumferential direction, the magnetic characteristics being generated by currents flowing through the respective rotor coils.

4. The rotary electric machine driving system according to claim 1, wherein
the rotor core includes salient poles that are the plurality of magnetic pole portions that are arranged at intervals in the circumferential direction of the rotor and that protrude toward the stator, and
the salient poles are magnetized as currents rectified by the rectifier unit flow through the rotor coils to thereby function as magnets having fixed magnetic poles.

5. The rotary electric machine driving system according to claim 3, wherein
the rotor core includes salient poles that are the plurality of magnetic pole portions that are arranged at intervals in the circumferential direction of the rotor and that protrude toward the stator, and
the salient poles are magnetized as currents rectified by the rectifier elements flow through the rotor coils to thereby function as magnets having fixed magnetic poles,
the rotor further has auxiliary rotor coils that are wound at proximal portions of the respective salient poles,
any two of the auxiliary rotor coils wound around any adjacent two of the salient poles in the circumferential direction of the rotor are connected in series with each other to constitute an auxiliary coil set, and
one ends of any adjacent two of the rotor coils, wound around any adjacent two of the salient poles in the circumferential direction of the rotor, are connected to each other at a connection point via the respectively corresponding rectifier elements such that the respectively corresponding rectifier elements face each other in opposite directions, the other ends of the any adjacent two of the rotor coils, wound around any adjacent two of the salient poles in the circumferential direction of the rotor, each are connected to one end of the auxiliary coil set, and the connection point is connected to the other end of the auxiliary coil set.

6. The rotary electric machine driving system according to claim 4, wherein
a width of each salient pole in the circumferential direction of the rotor is smaller than a width corresponding to 180° in electric angle, and each of the rotor coils is wound around a corresponding one of the salient poles by short pitch winding.

7. The rotary electric machine driving system according to claim 6, wherein
a width of each rotor coil in the circumferential direction of the rotor is equal to a width corresponding to 90° in electric angle.

8. The rotary electric machine driving system according to claim 5, wherein
a width of each salient pole in the circumferential direction of the rotor is smaller than a width corresponding to 180° in electric angle, and each of the rotor coils is wound around a corresponding one of the salient poles by short pitch winding.

9. The rotary electric machine driving system according to claim 8, wherein
a width of each rotor coil in the circumferential direction of the rotor is equal to a width corresponding to 90° in electric angle.
